(19) United States
(12) Patent Application Publication
(10) Pub. No.: US 2026/0112644 A1
(43) Pub. Date: Apr. 23, 2026

(54) Novel and Scalable Design for High Energy Density All-Solid-State Batteries

(71) Applicant: Northeastern University, Boston, MA (US)

(72) Inventor: Hongli Zhu, Newton, MA (US)

(21) Appl. No.: 19/277,557

(22) Filed: Jul. 23, 2025

Related U.S. Application Data
(60) Provisional application No. 63/674,363, filed on Jul. 23, 2024.

(51) Int. Cl. H01M 4/62; H01M 4/02; H01M 4/04; H01M 4/131; H01M 4/1391; H01M 4/36; H01M 4/525

(52) U.S. Cl. CPC H01M 4/628; H01M 4/043; H01M 4/131; H01M 4/1391; H01M 4/366; H01M 4/525; H01M 2004/021

(57) ABSTRACT

Disclosed herein is an electrode, comprising a first layer, a second layer, and a third layer, wherein: each of the first layer, the second layer, and the third layer comprises electrode-active material, solid electrolyte, and a carbon material; the first layer is coupled to the second layer; the second layer is coupled to the third layer; amount of the solid electrolyte in the first layer is greater than amount of the solid electrolyte in the second layer, and the amount of the solid electrolyte in the second layer is greater than amount of the solid electrolyte in the third layer; and the electrode has an electrode-active material loading of at least about 1 mg/cm².

### RELATED APPLICATION(S)

The application claims the benefit of U.S. Provisional Application No. 63/674,363, filed on Jul. 23, 2024. The entire teachings of the above application(s) are incorporated herein by reference.

### BACKGROUND

High mass-loading cathodes help achieve high energy density in all-solid-state batteries from lab scale to industry. However, as mass-loading increases, electrochemical performance is compromised due to sluggish kinetics.

### SUMMARY

In the present disclosure, operando neutron imaging of a high mass-loading NMC 811 cathode of 33 mg/cm² (5.0 mAh/cm², 180 μm thick) reveals the lithiation prioritization of the cathode-active material (CAM) from the solid electrolyte layer to the current collector side. In addition to the tortuosity, another key limitation to ion transfer in the cathode arises from the mismatch between the uniform distribution of the solid electrolyte (catholyte) in the conventional composite cathode and the non-uniform Li+ flux generated by the Faraday reaction of CAMs.

A novel design with a gradient in the catholyte concentration is engineered to match the Li+ flux distribution, aiming to eliminate the ion transfer obstacle. The approach disclosed herein demonstrates enhanced rate performance, even with ultra-high mass-loading cathodes. A LiCoO₂ composite cathode with 100 mg/cm² ultra-high mass-loading exhibited an areal capacity of 10.4 mAh/cm² at a current density of 2.25 mA/cm². This work demonstrated an effective gradient design to optimize ion transport in high mass-loading cathodes to overcome the kinetic barrier and achieve high battery performance.

In one embodiment, disclosed herein is an electrode, comprising a first layer, a second layer, and a third layer, wherein: each of the first layer, the second layer, and the third layer comprises electrode-active material, solid electrolyte, and a carbon material; the first layer is coupled to the second layer; the second layer is coupled to the third layer; amount of the solid electrolyte in the first layer is greater than amount of the solid electrolyte in the second layer, and the amount of the solid electrolyte in the second layer is greater than amount of the solid electrolyte in the third layer; and the electrode has an electrode-active material loading of at least about 1 mg/cm².

In another embodiment, disclosed herein is a method of forming an electrode comprising a first layer, a second layer, and a third layer, the method comprising: applying a first mixture comprising electrode-active material, solid electrolyte, and a carbon material onto a substrate to form the first layer; applying a second mixture comprising the electrode-active material, the solid electrolyte, and the carbon material onto the first layer to form the second layer; and applying a third mixture comprising the electrode-active material, the solid electrolyte, and the carbon material onto the second layer to form the third layer, thereby forming the electrode, wherein: each of the first layer, the second layer, and the third layer comprises the electrode-active material, the solid electrolyte, and the carbon material; the first layer is coupled to the second layer; the second layer is coupled to the third layer; amount of the solid electrolyte in the first layer is greater than amount of the solid electrolyte in the second layer, and the amount of the solid electrolyte in the second layer is greater than amount of the solid electrolyte in the third layer; and the electrode has an electrode-active material loading of at least about 1 mg/cm².

In another embodiment, disclosed herein is a battery comprising: a solid electrolyte; and an electrode of the present disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A-C: Schematics of different mass-loading cathodes in ASSBs and the setup of operando neutron imaging. FIG. 1A: Configurations with different mass-loading of the cathode and the influence factors for the kinetic issues in the thick cathode. FIG. 1B: Schematic of the experimental setup of operando neutron imaging. FIG. 1C: Schematic of the image calculation process. The results at different states: before charge, fully charge, and fully discharge, presented by the pseudo color images.

FIG. 2A: Front view of the setup of the Operando neutron imaging on Multimodal Advanced Radiography Station (MARS), HFIR beamline CG-1D, at Oak Ridge National Laboratory. FIG. 2B: Side view of the setup of the Operando neutron imaging on Multimodal Advanced Radiography Station (MARS), HFIR beamline CG-1D, at Oak Ridge National Laboratory.

FIG. 3: Charge and discharge profile for the Operando neutron imaging cell with thick cathode (33.3 mg/cm²), and the Operando electrochemical impedance spectroscopies (EISs) collected during cycling. Source data are provided as a Source Data file.

FIG. 4A: Voltage profiles for the Operando neutron imaging cell operated at the beamline with a variable room temperature (around 20° C.). FIG. 4B: Voltage profiles for the Operando neutron imaging cell operated at the home lab with a constant temperature of 25° C.

FIG. 5: Schematic of the sampling area for the neutron imaging analysis.

FIGS. 6A-C: Operando neutron imaging of the thick cathode in ASSBs. FIG. 6A: The average neutron transmission change ratio (Trₜ/Tr₀) of the operando neutron imaging cell as a function of time and the corresponding charge/discharge curve. FIG. 6B: Pseudo color 2D images of the operando cell at different state of charge (SOC). FIG. 6C: Pseudo color 2D images of the operando cell at different depth of discharge (DOD). FIG. 6D: Zoomed-in neutron transmission change (Trₜ/Tr₀) for the thick cathode layer during charging process with the corresponding voltage profile.

FIG. 7: Average neutron transmission change ratio (Trt/Tr0) of the thick cathode as a function of time and the corresponding voltage curve.

FIG. 8: Simulated SOC vs position and time during charge/rest. There is some evening out of the SOC locally, but not enough to create a uniform distribution in the cathode of this thickness.

FIG. 9: Zoomed-in neutron transmission change (Trₜ/Tr₀) for the thick cathode layer during discharge process. The color quickly turns to green after 23 hours due to the effect of ⁶Li⁺.

FIG. 10: The average neutron transmission change ratio (Trₜ/Tr₀) of the Operando neutron imaging cell with 16.7 mg/cm² cathode as a function of time and the corresponding charge/discharge curve.

FIG. 11: Zoomed-in neutron transmission change (Trₜ/Tr₀) for the thin cathode layer during charge and discharge process.

FIG. 12: Cycling stability of the composite cathode with the carbon nanofibers, the cells were initialized at C/10 for the first cycle and then cycled at 2C.

FIG. 13: Critical current density (CCD) test for the In—Li anode.

FIG. 14: Voltage profile of the CCD test for the In—Li anode.

FIGS. 15A-H: Electrochemical investigation of the ASSBs with different mass-loading cathode. FIG. 15A: Charge and discharge profiles of the ASSBs with different mass-loading cathode of 3 mg/cm². FIG. 15B: Charge and discharge profiles of the ASSBs with different mass-loading cathode of 10 mg/cm². FIG. 15C: Charge and discharge profiles of the ASSBs with different mass-loading cathode of 30 mg/cm². FIG. 15D: dQ/dV curves of the ASSBs with different mass-loading cathode of 3 mg/cm². FIG. 15E: dQ/dV curves of the ASSBs with different mass-loading cathode of 10 mg/cm². FIG. 15F: dQ/dV curves of the ASSBs with different mass-loading cathode of 30 mg/cm². FIG. 15G: Schematic of the setup for measuring the effective ion-conductivity of the composite cathode with the electron block electrode and the geometric definition of tortuosity. FIG. 15H: Schematic of the Li⁺ flux distribution crossing the thick cathode with faradaic reaction during charge and discharge.

FIG. 16A: Simulations of local particle surface SOC and particle average SOC as a function of position charged at C/2. FIG. 16B: Simulations of local particle surface SOC and particle average SOC as a function of position charged at 2C. The surface state of charge decreases as compared to the average state of charge for the higher charge rate due to increased gradients in SOC within the particle.

FIG. 17A: Simulations of local particle surface SOC and particle average SOC as a function of position for electrodes with a mass loading of 3 mg/cm². FIG. 17B: Simulations of local particle surface SOC and particle average SOC as a function of position for electrodes with a mass loading of 10 mg/cm². All were charged at C/2. FIG. 17C: Simulations of local particle surface SOC and particle average SOC as a function of position for electrodes with a mass loading of 30 mg/cm².

FIGS. 18A-H: Schematic and evaluation of the three-layer cathode with gradient design. FIG. 18A: Schematic of the three-layer cathode with gradient design. FIG. 18B: Design details of each layer corresponding to the Li⁺ flux over the thickness of the cathode. FIG. 18C: Comparison of the capacities at different rate of the three-layer cathode, reversed three-layer cathode, and the control group without the gradient design. FIG. 18D: Comparison of charge and discharge curves at C/20. FIG. 18E: Comparison of charge and discharge curves at C/10. FIG. 18F: Comparison of charge and discharge curves at 1C. FIG. 18G: dQ/dV curves at C/20. FIG. 18H: dQ/dV curves at C/10.

FIG. 19A: Voltage vs specific capacity for NMC electrode with mass loadings of 3 mg/cm² charged at several C-rates. FIG. 19B: Voltage vs specific capacity for NMC electrode with mass loadings of 10 mg/cm² charged at several C-rates. FIG. 19C: Voltage vs specific capacity for NMC electrode with mass loadings of 30 mg/cm² charged at several C-rates.

FIG. 20A: Simulated dQ/dV analysis for 3 mg/cm² mass loading charged at different rates. FIG. 20B: Simulated dQ/dV analysis for 10 mg/cm² mass loading charged at different rates. FIG. 20C: Simulated dQ/dV analysis for 30 mg/cm² mass loading charged at different rates.

FIG. 21: Simulated SOC distribution in the three-layer design, reversed three layer design, and conventional design for an NMC cathode charged at C/2 with a mass loading of 30 mg/cm². There is a clear increase in local SOC at the cathode/SE interface.

FIGS. 22A-C: Rate and cycling performance of thin LCO cathode (3 mg/cm² with 65 wt % of LCO). FIG. 22A: Comparison of the capacities at different rate of the three-layer cathode (in red) and the control group without the gradient design (in blue). FIG. 22B: Voltage vs specific capacity for the LCO cathode charged at different rates. FIG. 22C: Cycling stability of the LCO cathode with convention design (in blue) and with the three-layer design (in red).

FIG. 23A: dQ/dV curves of the ASSBs with 3 mg/cm² LCO cathode from C/10 to 2C. FIG. 23B: Zoom-in dQ/dV curves.

FIG. 24A-H: Electrochemical performances of the high mass-loading cathodes with the three-layer gradient design. FIG. 24A: Comparison of the rate performances of ASSBs 30 mg/cm² high mass-loading of LCO cathode with three-layer design and reversed three-layer cathode. FIG. 24B: Specific charge/discharge profiles of the three-layer cathode. FIG. 24C: Specific charge/discharge profiles of the reversed three-layer cathode. FIG. 24D: Comparison of the rate performances of ASSBs with three-layer cathode and conventional one-layer cathode with 100 mg/cm² high mass-loading of NMC 811 cathode. FIG. 24E: Charge/discharge profiles of batteries with three-layer cathode. FIG. 24F: Charge/discharge profiles of batteries with conventional one layer cathode. FIG. 24G: Comparison of the rate performances of ASSBs with three-layer cathode and traditional one-layer cathode with 100 mg/cm² high mass-loading of LCO cathode. FIG. 24H: Charge/discharge profiles of batteries with three-layer cathode. FIG. 24I: Charge/discharge profiles of batteries with conventional one-layer cathode.

FIG. 25: The rate performance of ASSBs with the 30 mg/cm² three-layer cathode to the cell fail.

FIG. 26: The rate performance of ASSBs with the 100 mg/cm² three-layer cathode to the cell fail.

FIG. 27: Charge/discharge profiles from cycle 34 to 43 of the battery with 30 mg/cm² three-layer LCO cathode.

FIG. 28: Charge/discharge profiles from cycle 29 to 34 of the battery with 30 mg/cm² three-layer LCO cathode.

FIG. 29: Equilibrium potential of NMC811 used in p2D model.

FIG. 30A: Simulated voltage profiles (V) vs. specific capacity for three-layer, reversed-three layer and conventional designs at C/10. FIG. 30B: Simulated voltage profiles (V) vs. specific capacity for three-layer, reversed-three layer and conventional designs at C/2. FIG. 30C: Simulated voltage profiles (V) vs. specific capacity for three-layer, reversed-three layer and conventional designs at 1C. Trends of improved charging capacity of the three-layer design are indicated with arrows.

### DETAILED DESCRIPTION

A description of example embodiments follows.

All-solid-state batteries (ASSBs) are among the most promising next-generation energy storage technologies, offering the potential for high energy density and significantly enhanced safety by replacing flammable organic liquid electrolytes (LEs) with nonflammable inorganic solid electrolytes (SEs).¹ To improve energy density, many researchers have focused on developing electrode materials with high specific capacity or high potential. However, the cell level energy density is much lower than that of the material level because of the substantial content of inactive materials, such as the battery case, current collectors, solid electrolytes, and other components that do not directly contribute to capacity. Therefore, increasing the mass-loading of the cathode is considered to be one of the most effective strategies for enhancing the proposed high energy density at the cell level.²

Achieving excellent electrochemical performance in high mass-loading cathodes is significantly more challenging than in thin cathodes. In the thick electrode, the higher areal current density under the same C-rate leads to a much larger ohmic polarization across the entire cell, and the increased tortuosity and longer diffusion paths result in sluggish ionic and electronic transport kinetics.³⁻⁵ The specific mechanism of the decay of the rate performance in thick electrodes is more complicated, especially for the ion transfer. In LEs, the transport of Li⁺ is based on the combination of electric field-induced migration and salt concentration gradient-induced diffusion.⁶ Under the high rate, a large Li salt concentration gradient in the liquid phase will be formed and further hinder the Li⁺ diffusion, and the Li⁺ depletion in the LE will cause the underutilization of the cathode active materials (CAMs).^{7,8} However, for the inorganic SE used in ASSBs, anions are fixed, and Li⁺ is the only ion that can move with a Li⁺ transference number around 1.0. Thus, there is no Li⁺ gradient or concertation change in SEs. Moreover, an increasing number of SEs demonstrate high ionic conductivities, sometimes surpassing those of LEs.⁹⁻¹² Therefore, ASSBs are supposed to have improved rate capabilities.¹³ Although impressive rate performance (>40C) has been achieved in ASSBs, the cathode mass-loading is usually low (<5 mg/cm²).^{14,15} The rate performances of high mass-loading cathode ASSBs still fall short of expectations.

In the composite cathode of ASSBs, the Li⁺ ion transfer paths are formed solely by the solid-solid contact between the CAM and SE particles. Compared to LE-based batteries, thick cathodes in ASSBs exhibit much higher tortuosity and lower effective ionic conductivity.^{16,17} The size, proportion, and arrangement of the CAM, SE, and electron-conductive additive particles must be optimized carefully.¹⁸ Inspired by the LE-based batteries, low ionic tortuosity design has been introduced to the ASSBs by mixing different sizes of SE particles to improve the rate performance.¹⁹ Nevertheless, despite the absence of Li⁺ concentration gradients in SEs, recent studies have still observed non-uniform reactions of CAMs in ASSBs.^{20,21} Given the unique physical properties of SEs compared to LEs, the impact of these properties on the performance of thick electrodes in ASSBs remains unclear. Therefore, it is crucial to investigate kinetic transfer in high mass-loading cathodes using direct operando visualization techniques and provide insights for designing thick cathodes with uniform and fast ion transport in all-solid-state systems.

Operando and in-situ investigation with sufficient temporal and spatial resolution is significant to understanding the kinetics of the thick cathode (>100 μm) in ASSBs, especially by tracking the Li behavior and reaction uniformity on the electrode level. Conventional characterization methods, such as electron-beam and optical-light-based methods, are hard to detect the electrochemical reaction of CAM.²² X-ray-based methods is difficult to detect Li directly due to its low X-ray attenuation coefficient of Li.²³ X-ray diffraction (XRD) and X-ray absorption spectroscopy (XAS) are powerful tools to detect the state of charge (SOC) evolution of CAM,^{24,25} but these spectroscopy-based data often lack the ability to provide operando visualization with a large characterization area. In contrast, neutron imaging shows unique advantages for tracking Li transport on account of the high visibility of Li for both ionic and metallic states.^{22,23,26-28} In addition, neutron imaging also has great Li isotope contrast, so it can be used to track Li⁺ diffusion in the solid electrolyte.²⁹ Consequently, neutron imaging is a powerful operando characterization method for ASSBs.

Herein, to identify the limit factor of the electrochemical reaction in thick cathodes in ASSBs, operando neutron imaging was successfully conducted to visualize the reaction gradient over the whole thick cathode with a mass-loading of 33 mg/cm² (˜180 μm thick). By performing image calculation, the spatial inhomogeneous reaction of CAMs was observed. Combined with electrochemical analysis, the mismatch between the non-uniform Li⁺ flux and the homogeneous SE distribution in the thick cathode is identified as the main cause of poor electrochemical performance. Inspired by the visualized electrochemical reaction gradient within the thick cathode, a three-layer cathode with a catholyte content gradient was strategically designed to promote fast Li⁺ transport and uniform reaction throughout the entire thick cathode. By tailoring the catholyte content to match the Li⁺ flux at different depths within the cathode, this design aims to alleviate the kinetic limitations observed in high mass-loading all-solid-state battery cathodes, ultimately leading to enhanced electrochemical rate performance. As a result, high mass-loading cathodes, 100 mg/cm² with theoretical areal capacities of 15.0 mAh/cm² for LiNi_{0.8}Co_{0.1}Mn_{0.1}O₂ (NMC 811) and 11.25 mAh/cm² for LiCoO₂(LCO), with three-layer design showed significantly improved rate performances compared to that of the thick cathode without SE gradient under the same CAMs content.

The present disclosure provides, among other things, electrodes comprising a first layer, a second layer, and a third layer. In some embodiments, each of the first layer, the second layer, and the third layer comprises one or more of: electrode-active material, solid electrolyte, and a carbon material. In some embodiments, each of the first layer, the second layer, and the third layer comprises: electrode-active material, solid electrolyte, and a carbon material. In some embodiments, the first layer is coupled to the second layer. In some embodiments, the second layer is coupled to the third layer. In some embodiments, amount of the solid electrolyte in the first layer is greater than amount of the solid electrolyte in the second layer, and the amount of the solid electrolyte in the second layer is greater than amount of the solid electrolyte in the third layer. In some embodiments, the electrode further comprises a current collector. In some embodiments, the third layer is coupled to the current collector. In some embodiments, the first layer is coupled to a solid electrolyte layer.

In some embodiments, disclosed herein is an electrode, comprising a first layer, a second layer, and a third layer, wherein: each of the first layer, the second layer, and the third layer comprises electrode-active material, solid electrolyte, and a carbon material; the first layer is coupled to the second layer; the second layer is coupled to the third layer; amount of the solid electrolyte in the first layer is greater than amount of the solid electrolyte in the second layer, and the amount of the solid electrolyte in the second layer is greater than amount of the solid electrolyte in the third layer; and the electrode has an electrode-active material loading of at least about 1 mg/cm² (e.g., at least about 2 mg/cm², at least about 3 mg/cm², at least about 4 mg/cm², at least about 5 mg/cm², at least about 6 mg/cm², at least about 7 mg/cm², at least about 8 mg/cm², at least about 9 mg/cm², at least about 10 mg/cm², at least about 15 mg/cm², at least about 20 mg/cm², at least about 25 mg/cm², at least about 30 mg/cm², at least about 35 mg/cm², etc.).

In some embodiments, the electrode has an electrode-active (e.g., cathode-active) material loading of at least about 1 mg/cm² (e.g., at least about 2 mg/cm², at least about 3 mg/cm², at least about 4 mg/cm², at least about 5 mg/cm², at least about 6 mg/cm², at least about 7 mg/cm², at least about 8 mg/cm², at least about 9 mg/cm², at least about 10 mg/cm², at least about 15 mg/cm², at least about 20 mg/cm², at least about 25 mg/cm², at least about 30 mg/cm², at least about 35 mg/cm², etc.). In some embodiments, the electrode-active material loading is at least about 20 mg/cm². In some embodiments, the electrode-active material loading is at least about 30 mg/cm². In some embodiments, the electrode-active material loading is about 100 mg/cm². In some embodiments, the electrode-active material loading is about 30 mg/cm². In some embodiments, the electrode-active material loading is about 33 mg/cm².

In some embodiments, disclosed herein is an electrode, comprising a first layer, a second layer, and a third layer, wherein: each of the first layer, the second layer, and the third layer comprises electrode-active material, solid electrolyte, and a carbon material; the first layer is coupled to the second layer; the second layer is coupled to the third layer; amount of the solid electrolyte in the first layer is greater than amount of the solid electrolyte in the second layer, and the amount of the solid electrolyte in the second layer is greater than amount of the solid electrolyte in the third layer; and the electrode has an electrode-active material loading of from about 1 mg/cm² to about 150 mg/cm² (e.g., about 1 mg/cm² to about 100 mg/cm², about 1 mg/cm² to about 90 mg/cm², about 1 mg/cm² to about 80 mg/cm², about 1 mg/cm² to about 70 mg/cm², about 1 mg/cm² to about 60 mg/cm², about 1 mg/cm² to about 50 mg/cm², about 1 mg/cm² to about 40 mg/cm², about 1 mg/cm² to about 30 mg/cm², about 5 mg/cm² to about 50 mg/cm², about 5 mg/cm² to about 40 mg/cm², about 5 mg/cm² to about 35 mg/cm², about 10 mg/cm² to about 40 mg/cm², about 10 mg/cm² to about 35 mg/cm², etc.).

In some embodiments, the electrode has an electrode-active (e.g., cathode-active) material loading of from about 1 mg/cm² to about 150 mg/cm² (e.g., about 1 mg/cm² to about 100 mg/cm², about 1 mg/cm² to about 90 mg/cm², about 1 mg/cm² to about 80 mg/cm², about 1 mg/cm² to about 70 mg/cm², about 1 mg/cm² to about 60 mg/cm², about 1 mg/cm² to about 50 mg/cm², about 1 mg/cm² to about 40 mg/cm², about 1 mg/cm² to about 30 mg/cm², about 5 mg/cm² to about 50 mg/cm², about 5 mg/cm² to about 40 mg/cm², about 5 mg/cm² to about 35 mg/cm², about 10 mg/cm² to about 40 mg/cm², about 10 mg/cm² to about 35 mg/cm², etc.). In some embodiments, the electrode-active material loading is from about 30 mg/cm² to about 40 mg/cm². In some embodiments, the electrode-active material loading is from about 30 mg/cm² to about 35 mg/cm².

In some embodiments, the amount of electrode-active (e.g., cathode-active) material in the electrode is at least about 50 wt. % (e.g., at least about 55 wt. %, at least about 60 wt. %, at least about 65 wt. %, at least about 70 wt. %, etc.). In some embodiments, the amount of electrode-active (e.g., cathode-active) material in the electrode is at least about 75 wt. %.

In some embodiments, the amount of electrode-active (e.g., cathode-active) material in the electrode is from about 50 wt. % to about 95 wt. % (e.g., about 50 wt. % to about 90 wt. %, about 50 wt. % to about 85 wt. %, about 50 wt. % to about 80 wt. %, about 55 wt. % to about 80 wt. %, about 60 wt. % to about 80 wt. %, about 65 wt. % to about 80 wt. %, about 70 wt. % to about 80 wt. %, etc.). In some embodiments, the amount of electrode-active (e.g., cathode-active) material in the electrode is about 75 wt. %.

In some embodiments, the amount of electrode-active (e.g., cathode-active) material in the first layer is from about 50 wt. % to about 80 wt. % (e.g., about 50 wt. % to about 75 wt. %, about 55 wt. % to about 75 wt. %, about 60 wt. % to about 75 wt. %, etc.). In some embodiments, the amount of the electrode-active (e.g., cathode-active) material in the first layer is from about 50 wt. % to about 80 wt. %. In some embodiments, the amount of the electrode-active (e.g., cathode-active) material in the first layer is about 65 wt. %.

In some embodiments, the amount of the solid electrolyte in the first layer is from about 25 wt. % to about 50 wt. % (e.g., about 25 wt. % to about 50 wt. %, about 25 wt. % to about 45 wt. %, about 25 wt. % to about 40 wt. %, about 30 wt. % to about 40 wt. %, etc.). In some embodiments, the amount of the solid electrolyte in the first layer is from about 30 wt. % to about 35 wt. %. In some embodiments, the amount of the solid electrolyte in the first layer is about 33 wt. %.

In some embodiments, the amount of carbon material in the first layer is from about 0 wt. % to about 5 wt. % (e.g., about 0 wt. % to about 4 wt. %, about 0 wt. % to about 3 wt. %, about 1 wt. % to about 3 wt. %, etc.). In some embodiments, the amount of the carbon material in the first layer is about 2.0 wt. %.

In some embodiments, the amount of electrode-active (e.g., cathode-active) material in the second layer is from about 50 wt. % to about 90 wt. % (e.g., about 50 wt. % to about 85 wt. %, about 55 wt. % to about 80 wt. %, about 60 wt. % to about 80 wt. %, etc.). In some embodiments, the amount of the electrode-active (e.g., cathode-active) material in the second layer is from about 70 wt. % to about 80 wt. %. In some embodiments, the amount of the electrode-active (e.g., cathode-active) material in the second layer is about 75 wt. %.

In some embodiments, the amount of the solid electrolyte in the second layer is from about 15 wt. % to about 25 wt. % (e.g., about 16 wt. % to about 25 wt. %, about 17 wt. % to about 25 wt. %, about 18 wt. % to about 25 wt. %, about 19 wt. % to about 25 wt. %, etc.). In some embodiments, the amount of the solid electrolyte in the second layer is from about 20 wt. % to about 25 wt. %.

In some embodiments, the amount of carbon material in the second layer is from about 0 wt. % to about 5 wt. % (e.g., about 0 wt. % to about 4 wt. %, about 0 wt. % to about 3 wt. %, about 0 wt. % to about 2 wt. %, about 1 wt. % to about 2 wt. %, etc.). In some embodiments, the amount of the carbon material in the second layer is about 1.5 wt. %.

In some embodiments, the amount of electrode-active (e.g., cathode-active) material in the third layer is from about 60 wt. % to about 95 wt. % (e.g., about 65 wt. % to about 95 wt. %, about 70 wt. % to about 95 wt. %, about 75 wt. % to about 95 wt. %, etc.). In some embodiments, the amount of the electrode-active (e.g., cathode-active) material in the third layer is from about 80 wt. % to about 90 wt. %. In some embodiments, the amount of the electrode-active (e.g., cathode-active) material in the third layer is about 85 wt. %.

In some embodiments, the amount of the solid electrolyte in the third layer is from about 0 wt. % to about 15 wt. % (e.g., about 5 wt. % to about 15 wt. %, about 6 wt. % to about 15 wt. %, about 7 wt. % to about 15 wt. %, about 8 wt. % to about 15 wt. %, about 9 wt. % to about 15 wt. %, etc.). In some embodiments, the amount of the solid electrolyte in the third layer is from about 10 wt. % to about 15 wt. %.

In some embodiments, the amount of carbon material in the third layer is from about 0 wt. % to about 3 wt. % (e.g., about 0 wt. % to about 2.5 wt. %, about 0 wt. % to about 2 wt. %, about 0 wt. % to about 1.5 wt. %, about 0.5 wt. % to about 1.5 wt. %, etc.). In some embodiments, the amount of the carbon material in the third layer is about 1.0 wt. %.

In some embodiments, the amount of the solid electrolyte in the first layer is from about 30 wt. % to about 35 wt. %; the amount of the solid electrolyte in the second layer is from about 20 wt. % to about 25 wt. %; and the amount of the solid electrolyte in the third layer is from about 10 wt. % to about 15 wt. %. In some embodiments, the amount of the solid electrolyte in the first layer is about 33 wt. %; the amount of the solid electrolyte in the second layer is about 23.5 wt. %; and the amount of the solid electrolyte in the third layer is about 14.0 wt. %.

In some embodiments, an electrode (e.g., an NMC cathode, an LCO cathode) has areal capacity of at least about 8 mAh/cm² (e.g., at least about 9 mAh/cm², at least about 10 mAh/cm², etc.) at a current density of about 2.25 mA/cm². In some embodiments, the electrode has areal capacity of about 10.4 mAh/cm² at a current density of about 2.25 mA/cm².

In some embodiments, an electrode has areal capacity of at least about 8 mAh/cm² (e.g., at least about 9 mAh/cm², etc.) at a current density of about 1.5 mA/cm². In some embodiments, the electrode has areal capacity of about 9.9 mAh/cm² at a current density of about 1.5 mA/cm².

In some embodiments, the electrode-active material comprises lithium, nickel, manganese, cobalt, or a combination thereof. In some embodiments, the electrode-active material comprises lithium, cobalt, or a combination thereof. For example, the electrode-active material is NMC, LCO, LiCoO₂, LiNiO₂, LiMn₂O₄, LiNi_{1/3}Mn_{1/3}Co₂O₂(NMC 111), NMC 532, NMC 622, NMC 712, NMC 90505, LiNiₓCo_{y}Al_{z}O₂ (NCA), LiNi_{0.8}Mn_{0.1}Co_{0.1}O₂(NCM 811) or LiMn_{1.5}Ni_{0.5}O₄(LNMO). In some embodiments, the electrode-active material comprises NMC. In some embodiments, the electrode-active material is LiCoO₂ (LCO) or LiNi_{0.8}Mn_{0.1}Co_{0.1}O₂. In some embodiments, the electrode-active material is NMC 811. In some embodiments, the electrode-active material is LCO.

In some embodiments, the solid electrolyte comprises lithium and sulfur. In some embodiments, the solid electrolyte is an argyrodite electrolyte. In some embodiments, the solid electrolyte is Li₆PS₅Cl. In some embodiments, the solid electrolyte is Li_{5.4}PS_{4.4}Cl_{1.6}.

Examples of carbon material include carbon black, graphite, graphene, carbon nanotubes, and carbon nanofibers. In some embodiments, the carbon material comprises carbon nanofibers.

In some embodiments, the electrode has a thickness of at least about 50 μm (e.g., at least about 60 μm, at least about 70 μm, at least about 80 μm, at least about 90 μm, at least about 100 μm, etc.). In some embodiments, the electrode has a thickness of at least about 100 μm.

In some embodiments, the electrode has a thickness of from about 50 μm to about 500 μm (e.g., about 100 μm to about 500 μm, about 100 μm to about 400 μm, about 100 μm to about 350 μm, about 100 μm to about 300 μm, etc.). In some embodiments, the electrode has a thickness of from about 100 μm to about 500 μm. In some embodiments, the electrode has a thickness of from about 100 μm to about 200 μm. In some embodiments, the electrode has a thickness of from about 150 μm to about 200 μm.

The present disclosure also provides, among other things, a battery comprising: a solid electrolyte; and an electrode of the present disclosure.

### Methods

The present disclosure provides, among other things, methods of forming an electrode comprising a first layer, a second layer, and a third layer. In some embodiments, each of the first layer, the second layer, and the third layer comprises one or more of: electrode-active material, solid electrolyte, and a carbon material. In some embodiments, each of the first layer, the second layer, and the third layer comprises: electrode-active material, solid electrolyte, and a carbon material. In some embodiments, the first layer is coupled to the second layer. In some embodiments, the second layer is coupled to the third layer. In some embodiments, amount of the solid electrolyte in the first layer is greater than amount of the solid electrolyte in the second layer, and the amount of the solid electrolyte in the second layer is greater than amount of the solid electrolyte in the third layer. In some embodiments, the electrode further comprises a current collector. In some embodiments, the third layer is coupled to the current collector. In some embodiments, the first layer is coupled to a solid electrolyte layer.

In some embodiments, the methods comprise: applying a first mixture comprising one or more of electrode-active material, solid electrolyte, or a carbon material onto a substrate to form the first layer; applying a second mixture comprising one or more of the electrode-active material, the solid electrolyte, or the carbon material onto the first layer to form the second layer; and applying a third mixture comprising one or more of the electrode-active material, the solid electrolyte, or the carbon material onto the second layer to form the third layer, thereby forming the electrode.

In some embodiments, the methods comprise: applying a first mixture comprising electrode-active material, solid electrolyte, and a carbon material onto a substrate to form the first layer; applying a second mixture comprising the electrode-active material, the solid electrolyte, and the carbon material onto the first layer to form the second layer; and applying a third mixture comprising the electrode-active material, the solid electrolyte, and the carbon material onto the second layer to form the third layer, thereby forming the electrode.

In some embodiments, disclosed herein is a method of forming an electrode comprising a first layer, a second layer, and a third layer, the method comprising: applying a first mixture comprising electrode-active material, solid electrolyte, and a carbon material onto a substrate to form the first layer; applying a second mixture comprising the electrode-active material, the solid electrolyte, and the carbon material onto the first layer to form the second layer; and applying a third mixture comprising the electrode-active material, the solid electrolyte, and the carbon material onto the second layer to form the third layer, thereby forming the electrode, wherein: each of the first layer, the second layer, and the third layer comprises the electrode-active material, the solid electrolyte, and the carbon material; the first layer is coupled to the second layer; the second layer is coupled to the third layer; amount of the solid electrolyte in the first layer is greater than amount of the solid electrolyte in the second layer, and the amount of the solid electrolyte in the second layer is greater than amount of the solid electrolyte in the third layer; and the electrode has an electrode-active material loading of at least about 1 mg/cm² (e.g., at least about 2 mg/cm², at least about 3 mg/cm², at least about 4 mg/cm², at least about 5 mg/cm², at least about 6 mg/cm², at least about 7 mg/cm², at least about 8 mg/cm², at least about 9 mg/cm², at least about 10 mg/cm², at least about 15 mg/cm², at least about 20 mg/cm², at least about 25 mg/cm², at least about 30 mg/cm², at least about 35 mg/cm², etc.).

In some embodiments, disclosed herein is a method of forming an electrode comprising a first layer, a second layer, and a third layer, the method comprising: applying a first mixture comprising electrode-active material, solid electrolyte, and a carbon material onto a substrate to form the first layer; applying a second mixture comprising the electrode-active material, the solid electrolyte, and the carbon material onto the first layer to form the second layer; and applying a third mixture comprising the electrode-active material, the solid electrolyte, and the carbon material onto the second layer to form the third layer, thereby forming the electrode, wherein: each of the first layer, the second layer, and the third layer comprises the electrode-active material, the solid electrolyte, and the carbon material; the first layer is coupled to the second layer; the second layer is coupled to the third layer; amount of the solid electrolyte in the first layer is greater than amount of the solid electrolyte in the second layer, and the amount of the solid electrolyte in the second layer is greater than amount of the solid electrolyte in the third layer; and the electrode has an electrode-active material loading of from about 1 mg/cm² to about 150 mg/cm² (e.g., about 1 mg/cm² to about 100 mg/cm², about 1 mg/cm² to about 90 mg/cm², about 1 mg/cm² to about 80 mg/cm², about 1 mg/cm² to about 70 mg/cm², about 1 mg/cm² to about 60 mg/cm², about 1 mg/cm² to about 50 mg/cm², about 1 mg/cm² to about 40 mg/cm², about 1 mg/cm² to about 30 mg/cm², about 5 mg/cm² to about 50 mg/cm², about 5 mg/cm² to about 40 mg/cm², about 5 mg/cm² to about 35 mg/cm², about 10 mg/cm² to about 40 mg/cm², about 10 mg/cm² to about 35 mg/cm², etc.).

In some embodiments, the substrate comprises the solid electrolyte.

In some embodiments, applying the first mixture comprises depositing the first mixture onto the substrate and pressing the deposited first mixture. In some embodiments, applying the second mixture comprises depositing the second mixture onto the first layer and pressing the deposited second mixture. In some embodiments, applying the third mixture comprises depositing the third mixture onto the second layer and pressing the deposited third mixture.

In some embodiments, applying the first mixture comprises depositing the first mixture onto the substrate and pressing the deposited first mixture at about 10 MPa. In some embodiments, applying the second mixture comprises depositing the second mixture onto the first layer and pressing the deposited second mixture at about 10 MPa. In some embodiments, applying the third mixture comprises depositing the third mixture onto the second layer and pressing the deposited third mixture at about 10 MPa.

In some embodiments, methods of the present disclosure further comprise applying a pressure to the electrode. In some embodiments, a pressure of about 300 MPa is applied. In some embodiments, the pressure is applied using two steel pillars.

In some embodiments, the first layer is coupled to the second layer. In some embodiments, the second layer is coupled to the third layer. In some embodiments, amount of the solid electrolyte in the first layer is greater than amount of the solid electrolyte in the second layer, and the amount of the solid electrolyte in the second layer is greater than amount of the solid electrolyte in the third layer.

In some embodiments, the electrode has an electrode-active (e.g., cathode-active) material loading of at least about 1 mg/cm² (e.g., at least about 2 mg/cm², at least about 3 mg/cm², at least about 4 mg/cm², at least about 5 mg/cm², at least about 6 mg/cm², at least about 7 mg/cm², at least about 8 mg/cm², at least about 9 mg/cm², at least about 10 mg/cm², at least about 15 mg/cm², at least about 20 mg/cm², at least about 25 mg/cm², at least about 30 mg/cm², at least about 35 mg/cm², etc.). In some embodiments, the electrode-active material loading is at least about 20 mg/cm².

In some embodiments, the electrode has an electrode-active (e.g., cathode-active) material loading of from about 1 mg/cm² to about 150 mg/cm² (e.g., about 1 mg/cm² to about 100 mg/cm², about 1 mg/cm² to about 90 mg/cm², about 1 mg/cm² to about 80 mg/cm², about 1 mg/cm² to about 70 mg/cm², about 1 mg/cm² to about 60 mg/cm², about 1 mg/cm² to about 50 mg/cm², about 1 mg/cm² to about 40 mg/cm², about 1 mg/cm² to about 30 mg/cm², about 5 mg/cm² to about 50 mg/cm², about 5 mg/cm² to about 40 mg/cm², about 5 mg/cm² to about 35 mg/cm², about 10 mg/cm² to about 40 mg/cm², about 10 mg/cm² to about 35 mg/cm², etc.).

In some embodiments, the amount of the solid electrolyte in the first layer is from about 25 wt. % to about 50 wt. % (e.g., about 25 wt. % to about 50 wt. %, about 25 wt. % to about 45 wt. %, about 25 wt. % to about 40 wt. %, about 30 wt. % to about 40 wt. %, etc.). In some embodiments, the amount of the solid electrolyte in the first layer is from about 30 wt. % to about 35 wt. %.

In some embodiments, the amount of the solid electrolyte in the second layer is from about 15 wt. % to about 25 wt. % (e.g., about 16 wt. % to about 25 wt. %, about 17 wt. % to about 25 wt. %, about 18 wt. % to about 25 wt. %, about 19 wt. % to about 25 wt. %, etc.). In some embodiments, the amount of the solid electrolyte in the second layer is from about 20 wt. % to about 25 wt. %.

In some embodiments, the amount of the solid electrolyte in the first layer is from about 0 wt. % to about 15 wt. % (e.g., about 5 wt. % to about 15 wt. %, about 6 wt. % to about 15 wt. %, about 7 wt. % to about 15 wt. %, about 8 wt. % to about 15 wt. %, about 9 wt. % to about 15 wt. %, etc.). In some embodiments, the amount of the solid electrolyte in the third layer is from about 10 wt. % to about 15 wt. %.

In some embodiments, the amount of the solid electrolyte in the first layer is from about 30 wt. % to about 35 wt. %; the amount of the solid electrolyte in the second layer is from about 20 wt. % to about 25 wt. %; and the amount of the solid electrolyte in the third layer is from about 10 wt. % to about 15 wt. %.

In some embodiments, the electrode-active material comprises lithium, nickel, manganese, cobalt, or a combination thereof. In some embodiments, the electrode-active material comprises lithium, cobalt, or a combination thereof. For example, the electrode-active material is LiCoO₂, LiNiO₂, LiMn₂O₄, LiNi_{1/3}Mn_{1/3}Co₂O₂(NCM111), NCM532, NCM622, NCM712, NCM811, NCM90505, LiNiₓCo_{y}Al_{z}O₂ (NCA), LiNi_{0.8}Mn_{0.1}Co_{0.1}O₂(NCM811) or LiMn_{1.55}Ni_{0.5}O₄(LNMO). In some embodiments, the electrode-active material is LiCoO₂ or LiNi_{0.8}Mn_{0.1}Co_{0.1}O₂.

In some embodiments, the solid electrolyte comprises lithium and sulfur. In some embodiments, the solid electrolyte is an argyrodite electrolyte. In some embodiments, the solid electrolyte is Li_{5.4}PS_{4.4}Cl_{1.6}.

Examples of carbon material include carbon black, graphite, graphene, carbon nanotubes, and carbon nanofibers. In some embodiments, the carbon material comprises carbon nanofibers.

In some embodiments, the electrode has a thickness of at least about 50 μm (e.g., at least about 60 μm, at least about 70 μm, at least about 80 μm, at least about 90 μm, at least about 100 μm, etc.). In some embodiments, the electrode has a thickness of at least about 100 μm.

In some embodiments, the electrode has a thickness of from about 50 μm to about 500 μm (e.g., about 100 μm to about 500 μm, about 100 μm to about 400 μm, about 100 μm to about 350 μm, about 100 μm to about 300 μm, etc.). In some embodiments, the electrode has a thickness of from about 100 μm to about 500 μm.

In some embodiments, methods of forming an electrode comprising a first layer, a second layer, and a third layer, comprise: applying a first mixture comprising electrode-active material, solid electrolyte, and a carbon material onto a substrate to form the first layer; applying a second mixture comprising the electrode-active material, the solid electrolyte, and the carbon material onto the first layer to form the second layer; and applying a third mixture comprising the electrode-active material, the solid electrolyte, and the carbon material onto the second layer to form the third layer, thereby forming the electrode, wherein: each of the first layer, the second layer, and the third layer comprises the electrode-active material, the solid electrolyte, and the carbon material; the first layer is coupled to the second layer; the second layer is coupled to the third layer; amount of the solid electrolyte in the first layer is greater than amount of the solid electrolyte in the second layer, and the amount of the solid electrolyte in the second layer is greater than amount of the solid electrolyte in the third layer; and the electrode has an electrode-active material loading of at least about 1 mg/cm².

The present disclosure also provides, among other things, methods of preparing a solid electrolyte. In some embodiments, methods of preparing a solid electrolyte comprise: mechanically processing a mixture comprising one or more (e.g., a plurality of) precursor components, and annealing the mechanically processed mixture.

In some embodiments, mechanically processing a mixture comprises milling (e.g., ball-milling) the mixture. In some embodiments, the mixture comprises Li₂S, P₂S₅, and LiCl. In some embodiments, the milling is performed at a speed of at least about 100 rpm (e.g., at least about 200 rpm, at least about 300 rpm, at least about 400 rpm, etc.). In some embodiments, the milling is performed at a speed of about 500 rpm. In some embodiments, the mixture is mechanically processed for at least about 1h. In some embodiments, the mixture is mechanically processed for about 10h.

In some embodiments, at least one of the one or more precursor components comprises lithium and sulfur. In some embodiments, the one or more precursor components are Li₂S, P₂S₅, and LiCl.

In some embodiments, the mechanically processed mixture is annealed at a temperature greater than about 100° C. (e.g., greater than about 200° C., greater than about 300° C., greater than about 400° C., greater than about 500° C., greater than about 600° C., etc.). In some embodiments, the mechanically processed mixture is annealed at a temperature of from about 400° C. to about 600° C. In some embodiments, the mechanically processed mixture is annealed at a temperature of about 510° C. In some embodiments, the mechanically processed mixture is annealed for a period of about 0.1 h to about 5 h (e.g., about 1 h to about 4 h, about 1 h to about 3 h, etc.). In some embodiments, the mechanically processed mixture is annealed for about 2 h.

### EXAMPLES

### Example 1

### Results and Discussion

### Visualizing Reaction Kinetics in High Mass-Loading Cathodes Through Operando Neutron Imaging

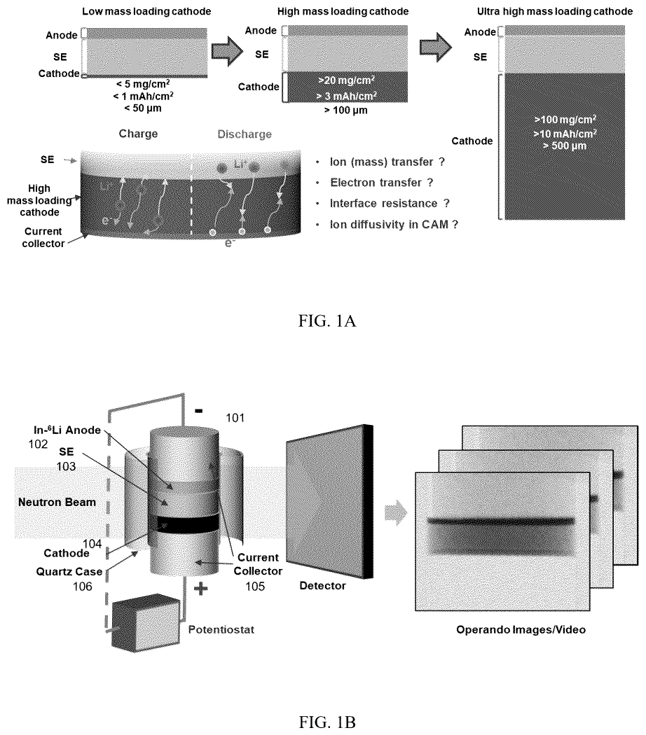

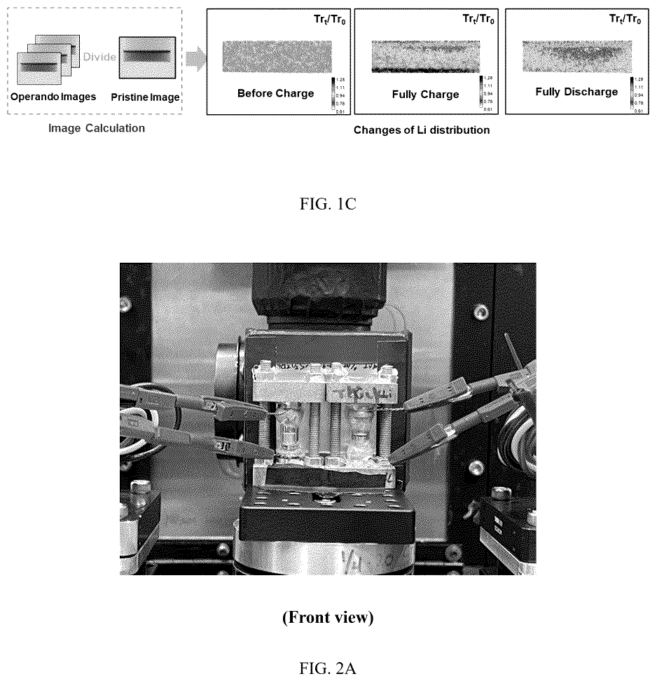

Low mass-loading cathodes (<5 mg/cm² or 1.0 mAh/cm²) are commonly employed in research to investigate the material-level capabilities and usually demonstrate excellent rate performance. However, as the cathode mass-loading increases, poor kinetics emerge as a significant issue. Ion transfer, electron transfer, interface resistance, ion diffusion, and electron transfer in the CAM are the most common factors contributing to kinetic limitations in composite cathodes (FIG. 1A). The ion and electron transfer will further affect the reaction prioritization and uniformity of CAM on the electrode level. Despite previous works demonstrating thick and high areal capacity cathodes (>10 mAh/cm²), this capacity was obtained at an low rate (0.025C), even when utilizing a highly ion-conductive SE with a conductivity of 32 mS/cm.⁹ Faster cycling of high mass-loading cathodes in ASSBs without compromising rate performance is crucial for real-world applications. However, the primary bottleneck for achieving high mass-loading cathodes in ASSBs remains unclear, so efforts to investigate cathode mass-loading are essential.

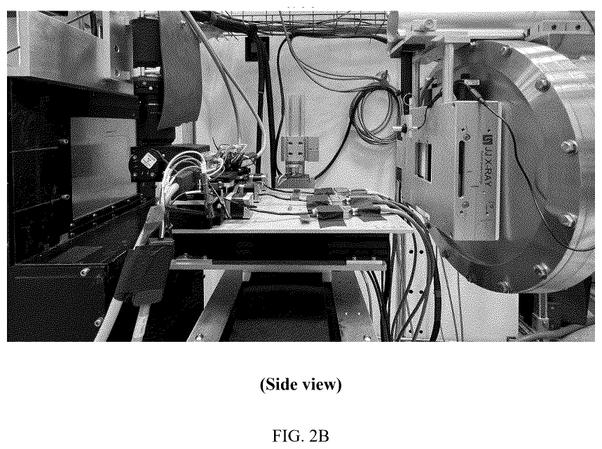

To unravel the reaction kinetic limitation, operando neutron imaging was carried out to visualize the reaction homogeneity within a thick cathode during charge and discharge processes (FIGS. 2A-B). FIG. 1B illustrates the mechanism and setup of an example operando neutron imaging for ASSBs. The operando cell 101, featuring a high mass-loading cathode 104 (33 mg/cm² and 5.0 mAh/cm²), was positioned vertically in front of the detector, aligning the layer interfaces parallel to the neutron beam. Anode 102, solid electrolyte 103, current collector 105 and quartz case 106 are also shown in FIG. 1B.

TABLE 1
Neutron attenuation coefficients for nature
Li, Li isotopes, and other materials

| Material | Neutron attenuation coefficient, Σ [cm⁻¹]* |
|---|---|
| Nature Li | 4.6964 |
| ⁶Li | 33.5047 |
| ⁷Li | 0.0543 |
| In | 10.3944 |
| Li_{5.4}PS_{4.4}Cl_{1.6}** | 2.4385 |
| ⁶Li_{5.4}PS_{4.4}Cl_{1.6} | 27.4019 |
| LiNi_{0.8}Mn_{0.1}Co_{0.1}O₂** | 2.8689 |
| Li_{0.5}Ni_{0.8}Mn_{0.1}Co_{0.1}O₂** | 1.8688 |

*All values are for cold neutrons at a wavelength of 2.53 Å
**Li element is nature Li

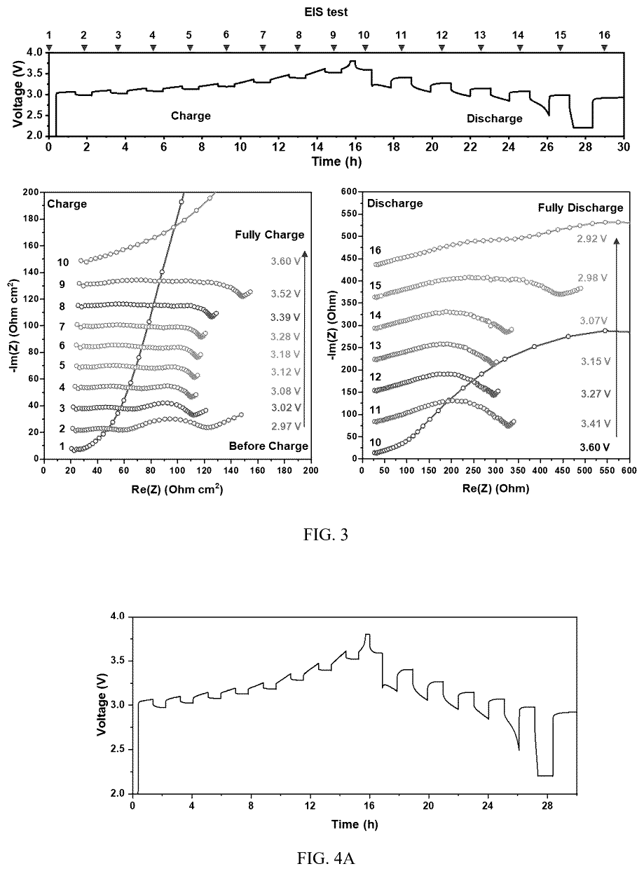

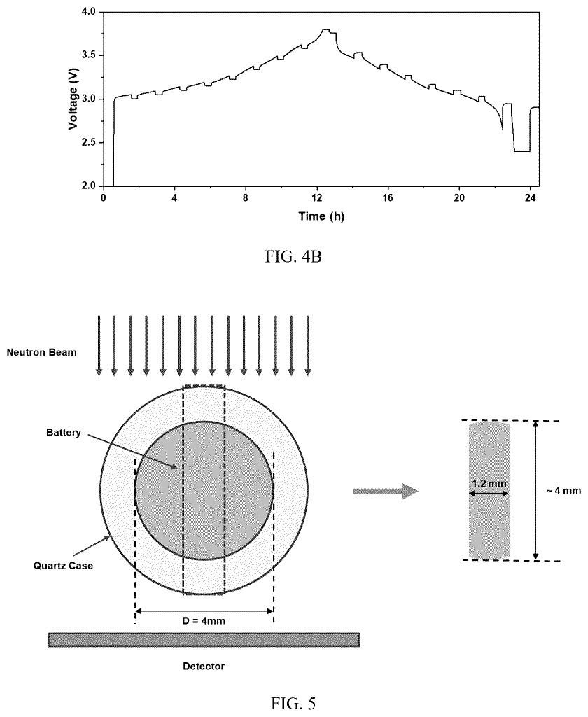

Given the distinct neutron attenuation coefficients of the materials in the ASSB (Table 1), the intensity of the transmitted neutron beam varies after passing through the battery. This variance facilitates easy differentiation between the cathode, SE, and anode layers based on the gray level, achieved by normalizing the neutron transmission intensity (Tr) from zero (no transmission) to one (full transmission). Darker areas correspond to lower neutron transmission, indicating that the material has a higher neutron attenuation coefficient. In the neutron image, the three layers—the In—⁶Li anode 102, SE 103, and the thick cathode 104 could be clearly recognized from top to bottom (FIG. 1B). Subsequently, the battery underwent charging and discharging processes while simultaneously collecting electrochemical impedance spectroscopy (EIS) data (FIG. 3) and operando neutron imaging data. Note that some variations in temperature and pressure affect the performance of the operando cell operated at the beamline, which are discussed in as follows in paras. 86-90 (FIGS. 4A-B).

FIG. 4 shows the voltage profiles of the operando neutron imaging cells operated at the beamline and in our lab with the same configuration. The EIS measurement for the cell we tested at our lab was from 1 MHz to 100 mHz, rather than 7 MHz to 10 mHz we took in the beamline. Therefore, the rest+EIS time is significantly shorter than the cell operated at the beamline. Moreover, we noticed that the overpotential of the cell operated at our lab is smaller than the cell operated at the beamline, and there is no obvious difference in the charge and discharge process. Here are a few reasons that may cause the differences between cells in our lab and in the Oak Ridge Beamline:
(1) Temperature: The temperature at the beamline was only around 20° C. and had a huge variation from day to night. In our lab, the room temperature was set at a constant value of 25° C. The temperature will affect the ion conductivity for both the solid electrolyte and CAM. The volume change due to the variation of the temperature will also affect the interface contact between particles. These further affect the performance and overpotential of the cell.
(2) Sealing: Although we adopted multiple sealing methods to prevent the leaking issue of our cell, including O-ring, sealing grease, and parafilm. However, the cell was tested after shipping to the Oak Ridge National Lab in a few days, with additional days of shelf storage. Therefore, the sealing may not be as good as we sealed it in the lab.
(3) Stacking pressure: Stacking pressure is important for the performance of the all-solid-state cell. The stacking pressure of our cell was added by the aluminum framework, with a certain torque applied to the nuts. We also added hot melt glue to prevent torque loss. However, after several days with the shipping process, the torque may be lower than what we fixed, which causes a loss of stacking pressure and further affects the performance.

Although the testing environment at the beamline may not be as ideal as the conditions set in our laboratory, our operando cell still performed effectively, yielding high-quality data. The environmental factors mentioned above do not alter the intrinsic mechanisms observed in our experiments.

To amplify the neutron transmission change of the cell during charge and discharge, the operando images were further calculated by dividing the image at the pristine state to get the transmission change ratio, Trₜ/Tr₀ (FIG. 1C). The pseudo color was applied to present the value of Trₜ/Tr₀ in the neutron image (FIG. 1D-F). For the area with limited transmission change (Trₜ/Tr₀≈1), the color remains green. The colors toward red and blue indicate the decrease (Trₜ/Tr₀<1) and increase (Trₜ/Tr₀>1) of the neutron transmission, respectively. The pseudo-color video presenting the transmission change over the charge and discharge process is in Supplementary Movie 1. Considering the cylindrical shape of the operando cell, which leads to different transmission lengths of the neutron beam over the cross-section and further affects the neutron transmission, we narrowed the sampling region to the center area (1.2 mm) of the cell with the transmission length close to the cell diameter (4 mm) to have the most reliable data (FIG. 5).

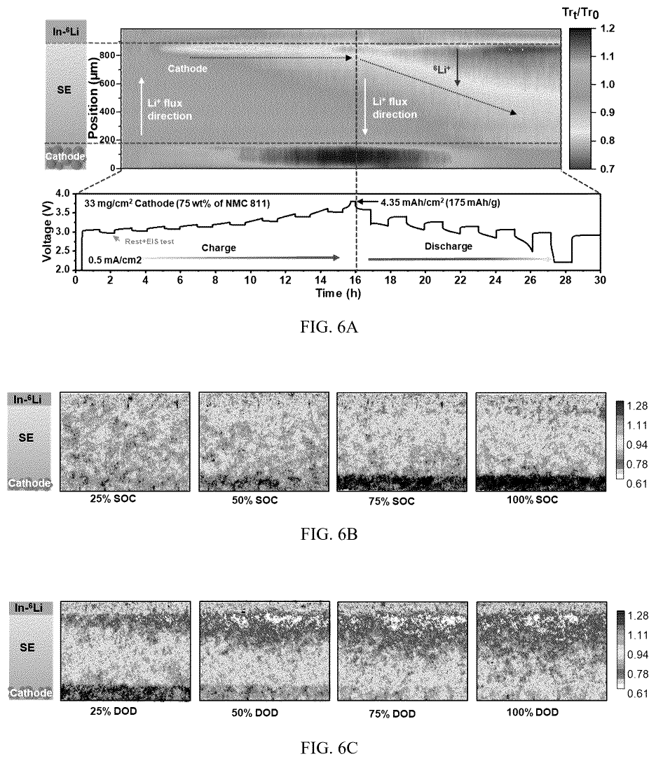

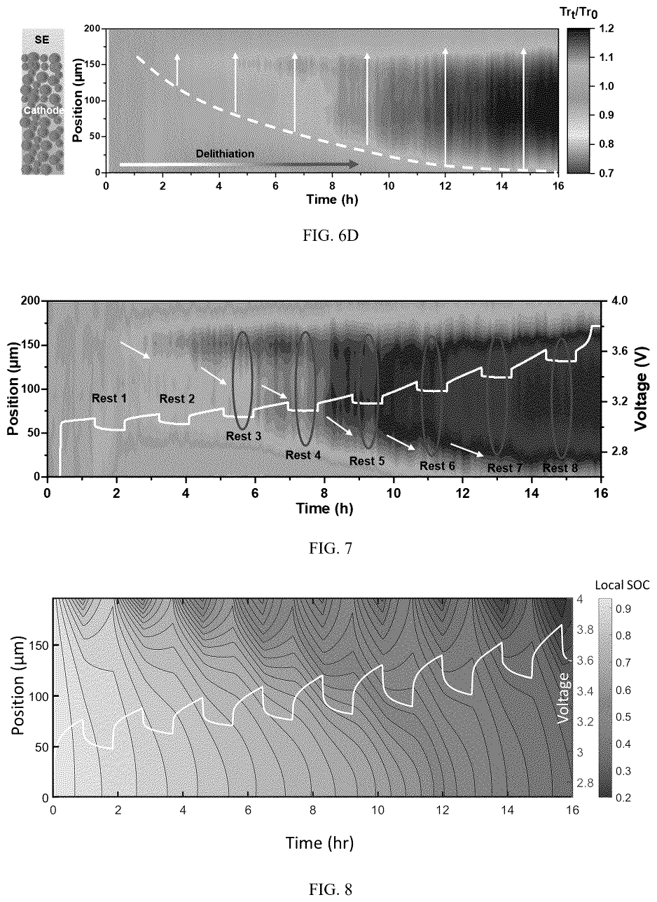

To better track the transmission changes over time, the average transmission change ratio of the sampling region of the operando battery is plotted in FIGS. 6A-B as a function of time with the corresponding charge/discharge profile. FIGS. 6C and 6D provide detailed 2D images at specific states of charge (SoC) and depth of discharge (DoD). We focused on the behaviors at the whole cell level. During the charging process, the colors of the cathode layer gradually changed to blue. This is because the CAM underwent a delithiation process, resulting in a decrease in the neutron attenuation coefficient (Table 1). The Li⁺ flux was directed toward the anode side during charging, but there was almost no transmission change in the SE layer with a thickness of around 700 m, proving that there was no Li⁺ concentration change in the SE layer, since Li⁺ in both CAM and SE are natural Li. A small amount of red color was observed at the interface between the SE and the In—⁶Li anode, caused by the self-diffusion of ⁶Li⁺ from the anode layer to the SE layer by replacing the natural Li⁺ in SE.³⁰ For the In—⁶Li anode layer, due to the high neutron attenuation coefficients of In and ⁶Li, the neutron transmission remained almost zero throughout the process under the current setup, resulting in no observable transmission change.

During the discharge process, the Li⁺ flux was directed toward the cathode side. As the CAMs underwent lithiation, the color of the cathode layer gradually turned back from blue to green after discharge. For the SE layer, based on the data from the charging process, Li⁺ flux did not affect the Li⁺ concentration and neutron attenuation coefficient of the SE layer. Therefore, in FIG. 6A, the enlargement of the red color region in SE during discharge was contributed by ⁶Li⁺ diffusing into the SE along with the Li⁺ flux. Because ⁶Li⁺ replaced the natural Li⁺ in the SE, the neutron attenuation coefficient of SE significantly increased (Table 1). A clear front of ⁶Li⁺ proceeding through the SE from the anode side to the cathode side was observed, which can also be seen in FIG. 6C as well as Supplementary Movie 1. The operando neutron imaging successfully visualized the Li⁺ diffusion in ASSBs from the anode to the cathode side through the SE layer during discharge based on the ⁶Li isotope.

The cathode layer was further magnified with the enhanced contract to investigate the delithiation uniformity of the CAM along the vertical direction (FIG. 6D). The thickness of the composite cathode layer with a mass-loading of 33 mg/cm² (5.0 mAh/cm²) is around 180 m. At the start of the discharge, it was hard to observe the transmission change because of the limited concentration change. After 3 hours, with a capacity of around 0.4 mAh/cm², the region close to the SE side started to turn blue. As mentioned above, this indicates the delithiation of the CAM. The cathode close to the current collector remained unchanged. As the charging time increased, a gradual movement of the reaction associated with the CAM delithiation was observed, progressing from the SE side toward the current collector side. After around 16 hours, the entire cathode turned blue with a specific charge capacity of 175 mAh/g with the voltage reaching 3.7 V (4.3 V vs Li/Li⁺). Note that the cell was charging for one hour and then rested for the EIS within the next hour. We can find that color change and gradient formation mainly happened in the charging process. During rests, the delithiation gradient was slightly reduced (red circles in FIG. 7). One hour of rest is not enough to let the SOC of the CAM become uniform in the whole cathode, and the rest does not affect the direction of the delithiation gradient that we found above. A corresponding simulation by Newman P2D model was further carried out as shown in FIG. 8 to exam our observation. Newman P2D model parameters are shown in Table 2.

TABLE 2
Modeling parameters for Newman P2D model of NMC811 with catholyte.

| Material | Value |
|---|---|
| Porosity | 0.25/0.25/0.25 |
| (For three layers, A/B/C) | |
| Solid fraction | 0.26/0.35/0.44 |
| (For three layers, A/B/C) | |
| Electrolyte fraction | 0.49/0.38//0.29 |
| (For three layers, A/B/C) | |
| Tortuosity | 5/19/42 |
| (For three layers, A/B/C) | 12/40/130 |
| Thickness (μm) | 130 |
| (For 3/10/30 mAh/g, | |
| Same properties as layer B) | |
| Thickness of trilayers (μm) | |
| Particle diameter (μm) | 4 |
| Diffusivity in solid (m²/s) | 3 × 10⁻¹⁶ |
| Maximum Li conc. in solid (mol/m³) | 40000 |
| Anodic transfer coefficient | 0.5 |
| Cathodic transfer coefficient | 0.5 |
| Surface Reaction rate | 1 × 10⁻¹¹ |
| $for cathode particles ( \frac{mol}{{m}^{2} s} {( \frac{mol}{{m}^{3}} )}^{- 1.5} )$ | |
| Electrolyte conductivity in catholyte | 0.1 S/m |
| Transference number of catholyte | 1 |
| Electrolyte conductivity in solid electrolyte | 0.5 S/m |
| Solid electrolyte thickness (μm) | 500 |
| Exchange current density of counter electrode | 8.5 |
| (A/m²) | |
| Anodic/cathodic transfer coefficient of counter | 0.5/0.5 |
| electrode | |

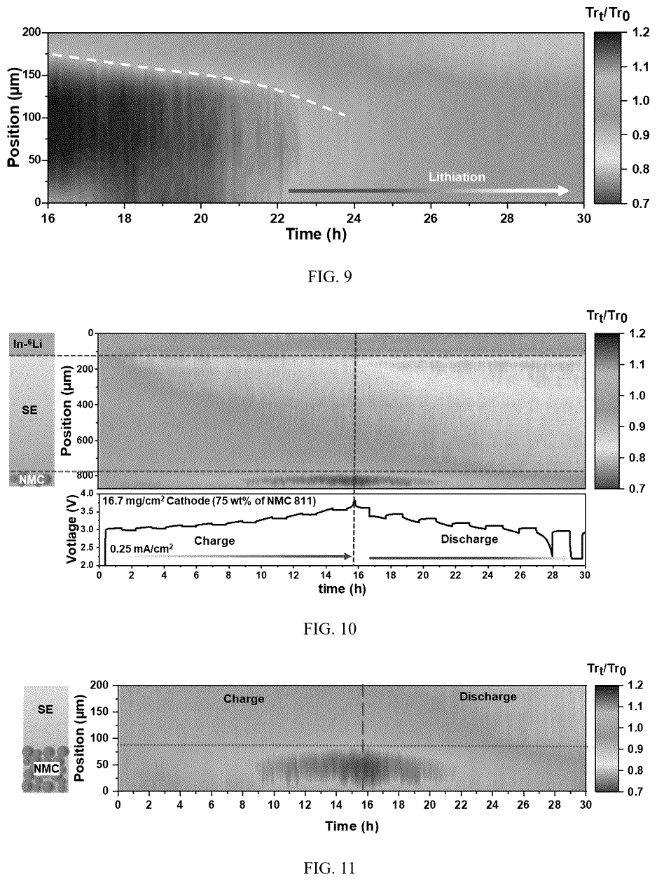

The simulation result is well aligned with our operando neutron image data, showing that changes delithiation gradients are minor during the rest stages. A similar trend was also observed for the discharge process (FIG. 9). The CAM close to the SE side first turned back to green, indicating that the lithiation process also started from the SE side.

A relatively thinner cathode (16.7 mg/cm²) was also characterized under the operando neutron imaging (FIG. 10). The reaction inhomogeneity is not obvious in the thin cathode (FIG. 11). Although both the thick and thin cathode cells were cycled under the same C-rate, the thin cathode cell shows small overpotential on account of the smaller areal current density. Moreover, the color change in the SE layer due to the ⁶Li⁺ diffusion in the discharge process was also much lighter in the thin cathode, reflecting the smaller Li⁺ flux and corresponding with the smaller current density.

### Identifying the Key Factors Limiting Ion Transport in Thick Cathodes

The reaction uniformity of the thick electrode is highly related to the reaction kinetics, especially the transport of charge carriers (both for ions and electrons). In the early studies of the composite cathode used in ASSBs, considering the decomposition of the SE when contacting the high surface area carbon, electron conductive additives (mainly carbon) were usually avoided in the composite cathode.^{31,32} The electron conductive pathway only relies on the contact between CAM particles. Therefore, the restriction of electron transport rises with the increase in SE content because of the contact loss between CAM particles.¹⁷ However, one-dimensional vapor growth carbon fibers have been proven to be ideal electron-conductive additives in ASSBs due to their excellent electrical conductivity. The decomposition of SE is significantly reduced in the composite cathode when using one-dimensional carbon fibers as the electron-conductive additive.³³ Based on our cycling test result (FIG. 12), there is almost no capacity decay. Therefore, the electron-conductive additives were applied in our composite cathode. Our operando neutron imaging data reveals that the delithiation/lithiation processes of CAM were nonuniform within the thick cathode. Most of the Li⁺ ions were first reacted in the area near the SE layer and hard to reach the CAM close to the current collector, indicating that the electrochemical reaction kinetics is primarily restricted by Li⁺ ion transport along the long pathway within the thick electrode, rather than by electron transfer.

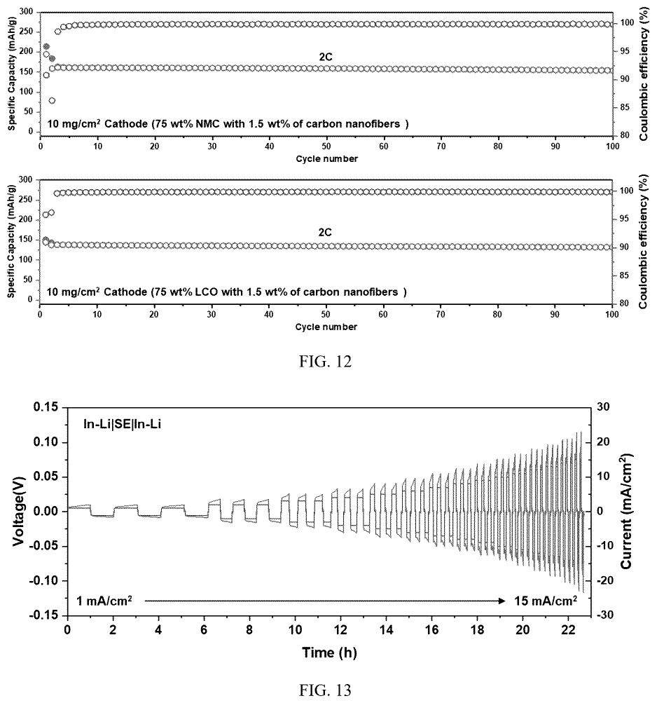

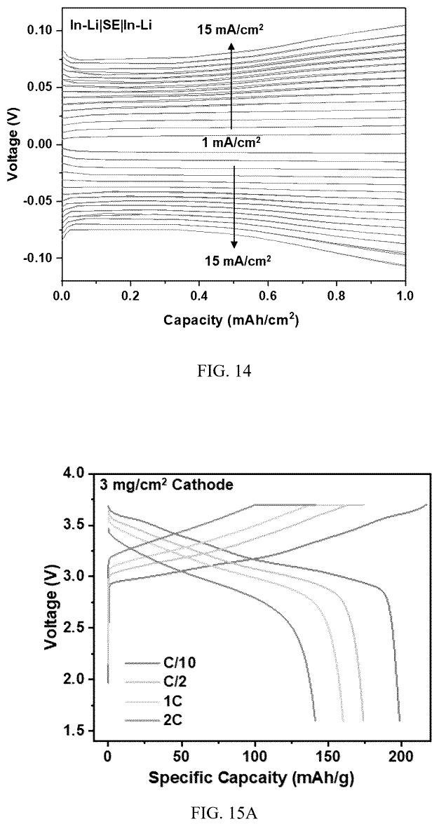

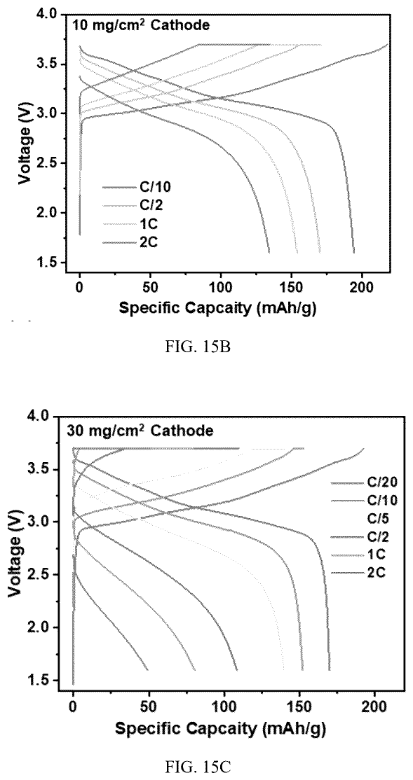

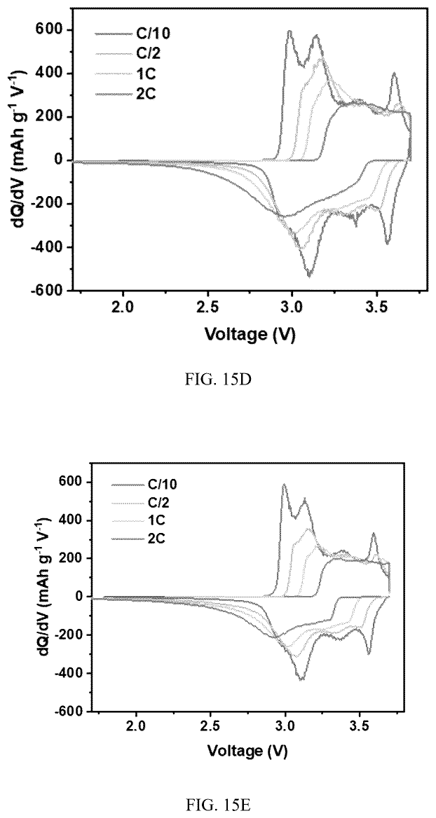

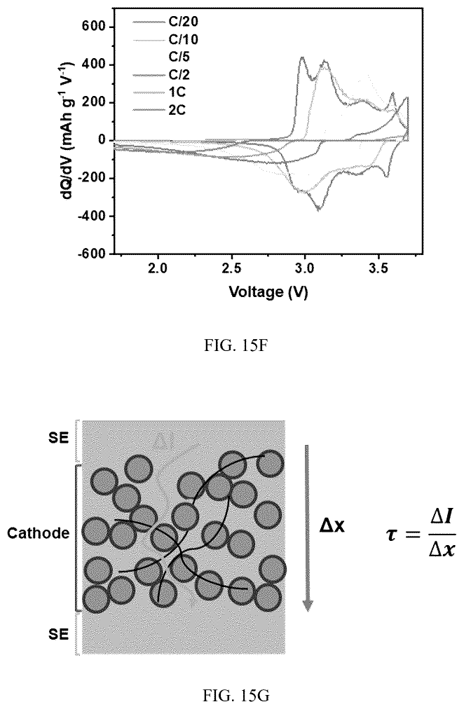

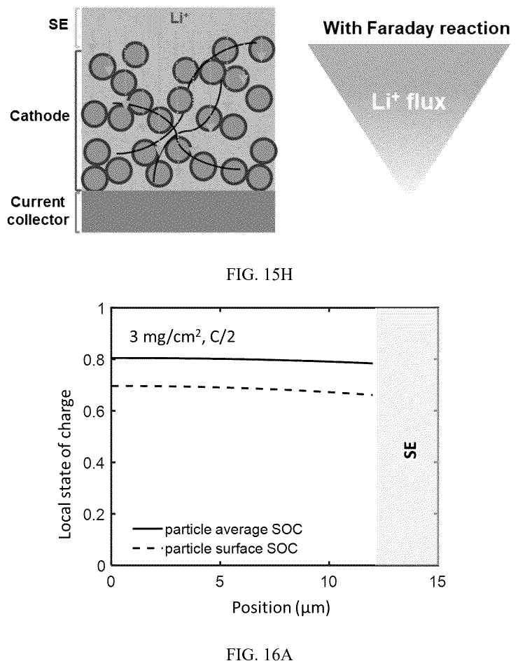

To further diagnose the ion transport limitation within the thick cathode, electrochemical performances were examined with different cathode mass-loadings of 3, 10, and 30 mg/cm² at 60° C. In—Li symmetric cells were also studied to evaluate the In—Li anode behavior and determine whether the anode contributes to the battery performance limitations. The symmetric cells maintained stable performance with limited overpotential (<100 mV), even at high current densities up to 15.0 mA/cm² (FIGS. 13 and 14). This result proved that the anode is not the main performance barrier in our ASSBs system. A low mass-loading (3 mg/cm²) cathode with high SE content (33.0 wt %) and sufficient carbon additives (2.0 wt % of carbon nanofibers) was tested to explore the intrinsic rate performance on the material level of NMC 811 with the minimum effect from the thickness. The cell shows a specific discharge capacity of 199 mAh/g at C/10, approaching the theoretical capacity of NMC 811 (FIG. 15A). At C/2, 1C, and 2C, the capacities were 174, 160, and 141 mAh/g, individually, representing the rate capacity of our NMC 811 at the material level under the condition with minimized limitations of the ion and electron transfer from the electrode level.

We further evaluated the rate performance for our normal cathode (75.0 wt % NMC with 1.5 wt % of carbon nanofibers) with mass-loadings of 10 and 30 mg/cm². When using a mass-loading of 10 mg/cm² with an areal capacity of 1.5 mAh/cm², there is no obvious decay of the rate performance, with the discharge capacities of 194, 170, 153, and 134 mAh/g at C/10, C/2, 1C, and 2C, individually (FIG. 15B). However, when the mass-loading increased to 30 mg/cm² with an areal capacity of 4.5 mAh/cm², the rate performance significantly decreased with the discharge capacities of 152, 140, 109, 80, and 49 mAh/g at C/10, C/2, 1C, and ^{2C}, individually (FIG. 15C), which are only 76%, 63%, 50% and 35% of them achieved in the 3 mg/cm² cell, respectively. The great rate performance of the 10 mg/cm² cathode was due to the short ion pathway within the thin electrodes, whereas the cell with 30 mg/cm² cathode showed much worse rate performance, suggesting the insufficient reaction of the cathode materials within the thick electrode because of sluggish ion transport along the long ion pathway.

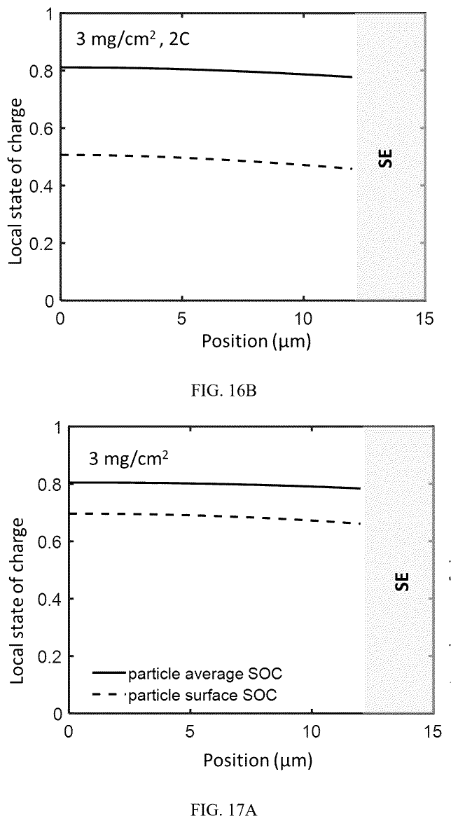

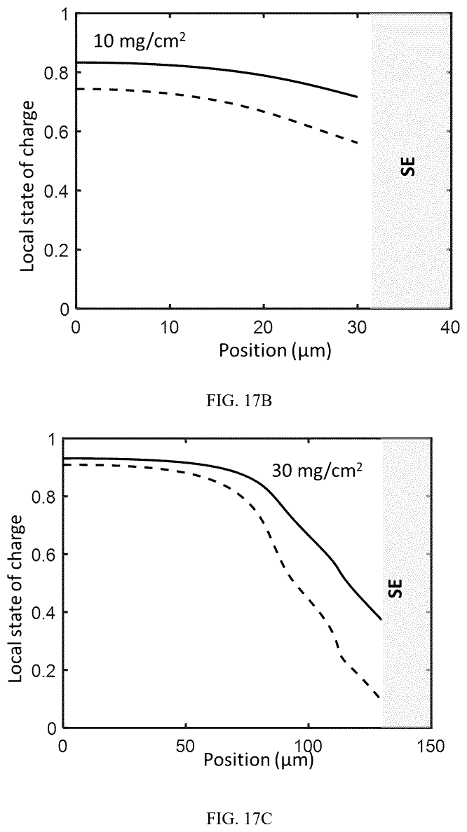

The reaction homogeneity at the electrode level can also be characterized by the dQ/dV analysis.³⁴ For the CAM (NMC 811), the intrinsic dQ/dV curve has four clear peaks representing the sequential intercalation reactions of NMC 811.35 As shown in FIG. 3d, the dQ/dV curve for the 3 mg/cm² cathode at the low rate (C/10) corresponds to the standard behavior of the CAM at the material level. The four peaks can be observed even at 1C. When the rate increases to 2C, the shape of the dQ/dV curve changes to a rounded rectangle. Since the cathode is very thin, this behavior mainly contributes to the rate capacity of CAM on the material level. In other words, it is due to the lithiation gradient on the particle level. We further conducted simulations of the SOC variation of the CAM under different rates with the Newman p2D model for the very thin cathode (3 mg/cm²) to explain this phenomenon, as shown in FIG. 16. For the very thin cathode, the lithiation inhomogeneity comes mainly from the particle level rather than the electrode level. For increased mass loading (10 and 30 mg/cm²), both through-thickness and intra-particle lithiation gradients are observed (FIG. 17).

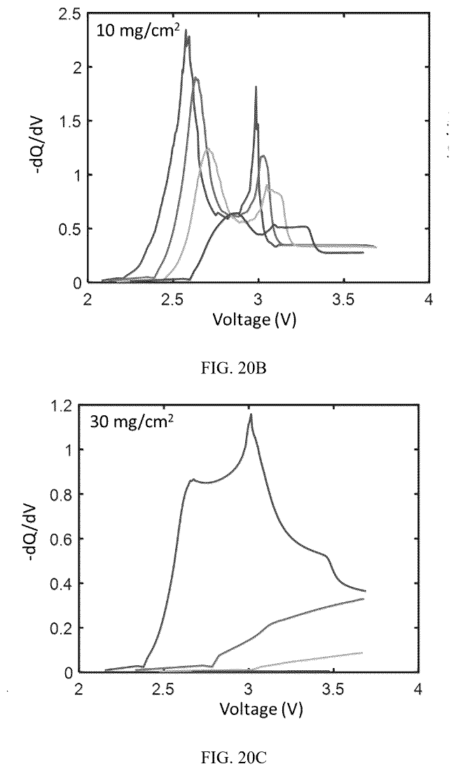

Using the dQ/dV curves of the 3 mg/cm² cathode as the baseline, we further analyzed the effects of the increase in mass-loading. For the cathodes with 10 and 30 mg/cm² mass-loadings (FIG. 15E, F), both cells show four pairs of peaks indicating uniform and sequential multiphase transitions under a low rate of C/10 or C/20. With the increase in the rate, the change of the dQ/dV curves of the 10 mg/cm² mass-loading cathode is similar to our baseline. However, for the cathode with 30 mg/cm² mass-loading, the trend of the dQ/dV curves varies with the increase of the C-rate. Even at C/10, four pairs of peaks are difficult to observe. At C/5, there is a peak emerging at 3.4 V (FIG. 15F), which is a peak but not a shift of peak two because it cannot be simply corrected by the IR drop.³⁴ The shape of the dQ/dV curve for oxidation transforms into a semi-isosceles triangle (yellow line in FIG. 15F). When the rate increases to C/2, the shape of the dQ/dV curve of the thick cathode becomes a right triangle (blue line in FIG. 15F), which is significantly different from that of the thin cathode of 3 and 10 mg/cm². The sequential intercalation reactions of NMC 811 were completely unobservable. Although the lithiation inhomogeneity that happened on both particle level and electrode level can affect the dQ/dV curve, the different behavior of the 30 mg/cm² when compared with the 3 mg/cm² and 10 mg/cm² cathodes indicates that the huge inhomogeneity at the electrode level is the key reason that causing the obvious change of the dQ/dV curves of the thick cathode. The simulation results of local particle surface SOC and particle average SOC as a function of position for electrodes with different mass loadings (FIGS. 17A-C) also clearly demonstrated that SOC variation on the electrode level is much more severe than the SOC variation on the particle level for the thick cathode (30 mg/cm²), which is distinctive with the phenomenon of the thin cathodes (both 3 and 10 mg/cm²). The strange dQ/dV curves indicate the huge reaction inhomogeneity in the thick cathode of 30 mg/cm², especially at high rates, and corresponding well with the simulated dQ/dV curves (FIG. 20A-C), which is consistent with the findings from the operando neutron imaging.

While the electrochemical results and operando neutron imaging provide valuable insights into the reaction inhomogeneity and performance limitations in thick cathodes, it is essential to understand the underlying factors that contribute to these issues. In the conventional discussion, ionic tortuosity (τ) and effective ion conductivity are considered a key parameter of the kinetics of the cathode, which controls Li⁺ diffusion and transportation in the electrodes.^{21,36} Tortuosity is defined as the ratio of the actual path length through a structure (Δl) to the straight-line distance between the starting and end points of that pathway (Δx) (FIG. 15G).¹⁸ In order to reduce the tortuosity, many researchers focus on building continuous ion transport pathways and low-tortuosity structural designs in ASSBs with great success.⁵ Nevertheless, in the thick cathode, we should notice that the distribution of Li⁺ flux on the whole electrode level will be dramatically different from the current collector side to the SE side because of the accumulation of Li⁺ flux generated from the faradaic reaction of the CAM with the increase of the thickness, as shown in FIG. 15H. From the aspect of the distribution of Li⁺ flux, the ion-transfer channel requirement varies among the whole electrodes. To adapt the Li⁺ flux gradient, a gradient SE content design of the thick cathode in ASSBs was inspired by the gradient porosity design in the liquid electrolyte (LE) based batteries.³⁷⁻³⁹ Different from LE, there is no Li⁺ concentration variation in the SE with a transference number of 1, which avoids the occurrence of electrolyte depletion in the thick cathode of the LE-based batteries. In addition, according to the following equation relating concentration gradients and potential gradients to the current in the electrolyte phase:

$${i}_{l} = - {κ}_{eff} ∇ {ϕ}_{l} + ( \frac{2 {κ}_{eff} R T ( 1 - {t}_{+} )}{F} ) ( 1 + \frac{d ln {f}_{\pm }}{d ln c} ) ∇ ln c . \qquad ( 1 )$$

Where iₗ is the current in the electrolyte phase, κ_{eff} is the effective ionic conductivity, φₗ is the potential in the electrolyte, t₊ is the transference number, F is Faraday's constant,

$$\frac{d ln {f}_{\pm }}{d ln c}$$

is the activity, and c is the electrolyte concentration. A transference number of 1 results in the omission of the second term, which reduces potential gradients in the liquid electrolyte and therefore reaction inhomogeneity.⁴′ The absence of concentration gradients in SEs allows for more precise control over ion transport pathways to match the Li⁺ flux distribution at the electrode level. Therefore, appropriate allocation of SE gradient with Li⁺ flux over the thick cathode could effectively improve the rate performance.

### Gradient Design in High Mass-loading Cathode for Enhancing Rate Performance

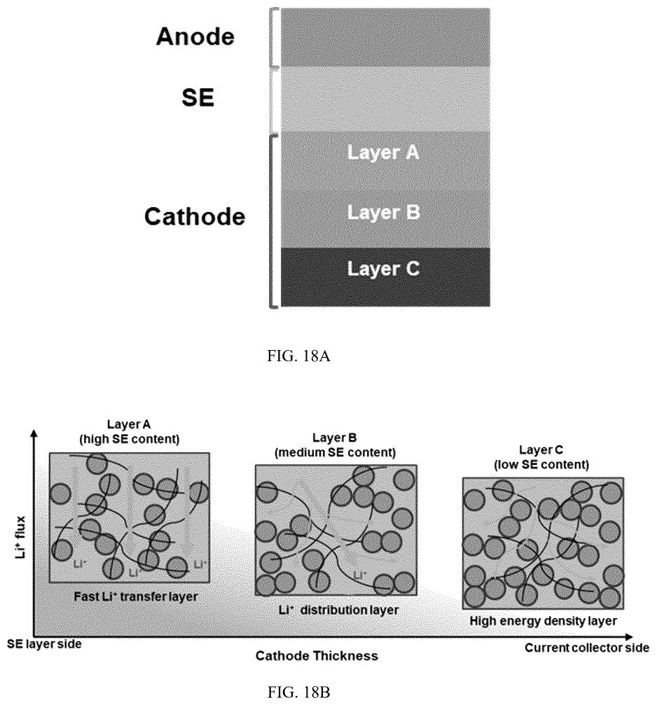

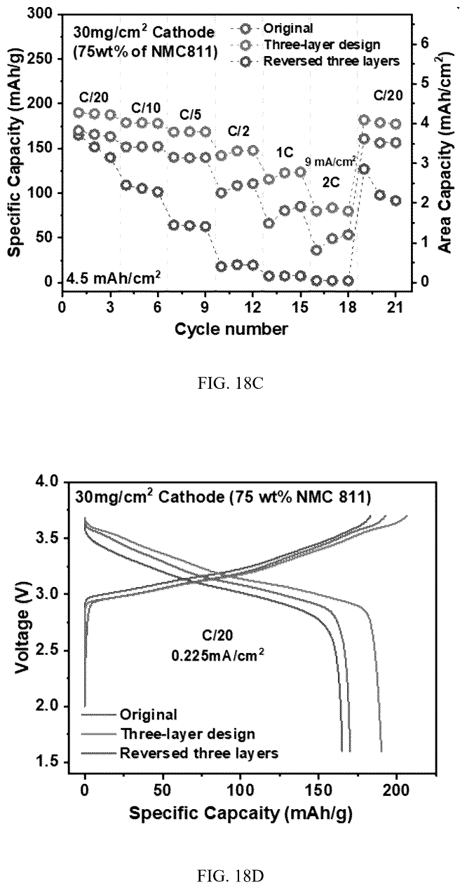

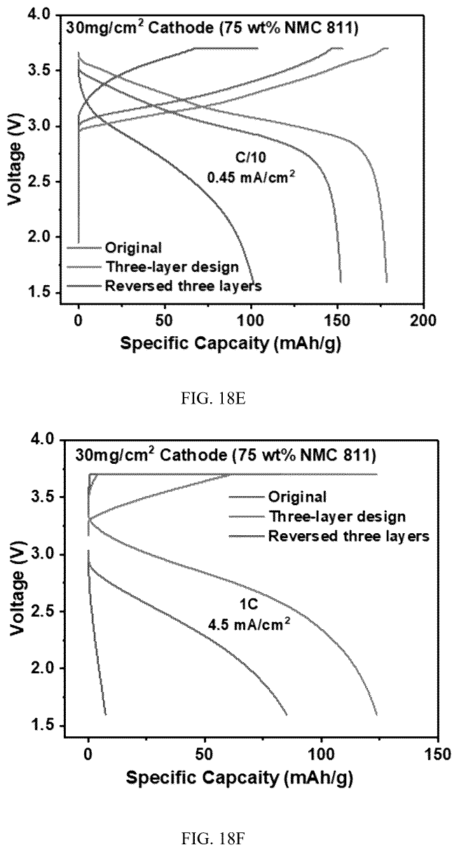

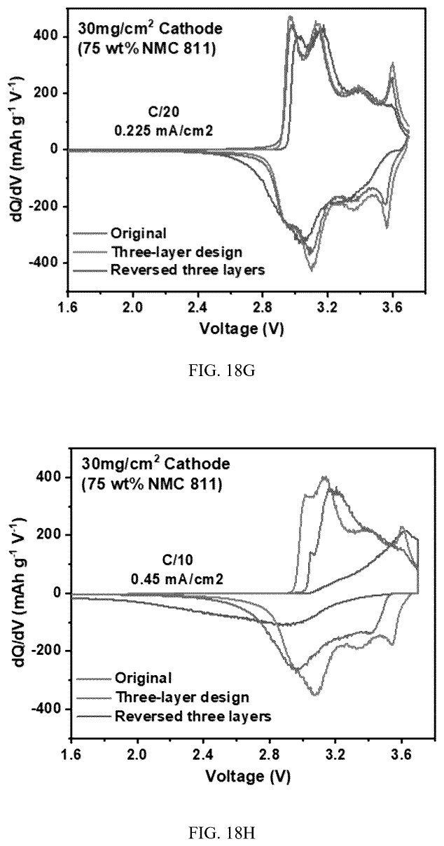

Inspired by the findings from the operando neutron imaging and the above-mentioned point of Li⁺ flux generated from the faradaic reaction, we designed a three-layer cathode with gradient ion transport channels for realizing homogenous electrochemical reaction and improved rate performance in the thick cathode by adjusting the SE content with the Li⁺ flux distribution (FIGS. 18A and 18B). The overall CAM content in the three-layer cathode was kept at 75.0 wt % which is the same as the non-gradient thick cathode. From the SE layer side to the current collector side, layer A is the fastest Li⁺ transfer layer with 65.0 wt. % of CAM, 33.0 wt. % of SE, and 2.0 wt % of carbon nanofibers. The highest content of SE is designed to bear the largest Li⁺ flux close to the SE layer. More carbon additives were also used to prevent the electron isolation of CAM due to the high SE content. Layer B is composed of 75.0 wt. % of CAM, 23.5 wt. % of SE, and 1.5 wt. % of carbon nanofibers, the same as the original composite cathode. Layer C is a high energy density layer with the highest CAM content (85.0 wt. %) and lowest SE content (14.0 wt. %). A compare group with a reversed sequence of the three layers was also prepared, as well as the control group with only one composition of 75.0 wt. % of CAM, 23.5 wt. % of SE, and 1.5 wt. % of carbon nanofibers.

The rate capabilities of the three different cathodes were compared to evaluate the superiority of our gradient design (FIG. 18C). The results show that the rate performance of the cell with the three-layer cathode outperforms that of the cell without a gradient design, even when tested under a very low current rate of C/20. The superiority of the gradient cathode is further exaggerated when the current rate increased from C/20 to high rates of C/10, C/5, C/2, 1C, and 2C (9.0 mA/cm²) with 112%, 119%, 120%, 135%, 155%, and 171% of the capacities obtained from the conventional cathode, individually. To further verify that the designed gradient ion transport channels can benefit the rate performance for the thick cathode, a reversed gradient cathode was examined, and it shows a much worse rate performance than that of the non-gradient cathode. Although the initial discharge capacity of the reversed three-layer cathode is very close to the original single-layer cathode at the low rate (C/20), its capacity decays dramatically as the rate increases. There is almost no capacity obtained when the rate is higher than C/2.

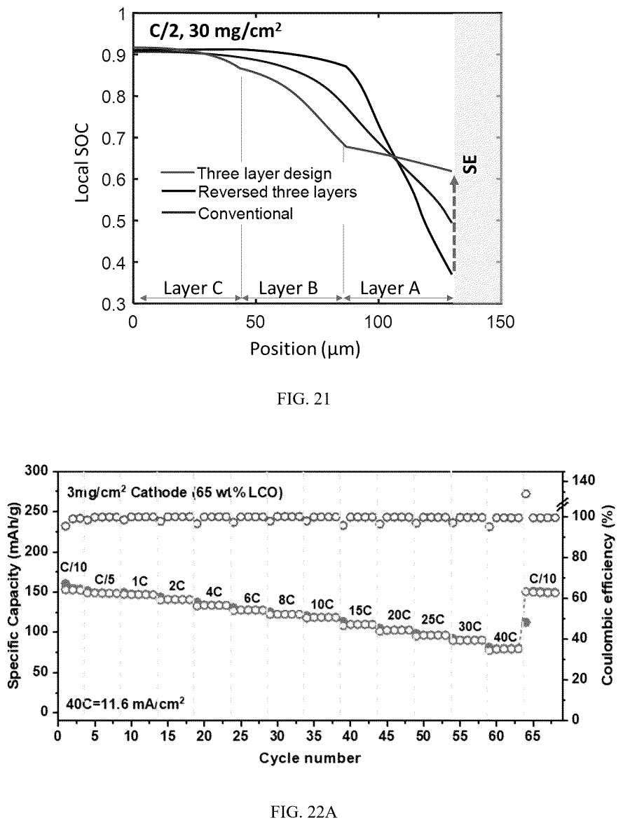

We further compared the charge/discharge profiles of these three groups to dig into the fundamentals of the three-layer design. Under the lowest rate we tested (C/20) with a current density of 0.225 mA/cm² (FIG. 18D), the three-layer cathode exhibited a noticeably smaller overpotential and larger capacity. As the C-rate increased, the advantage became more pronounced (FIGS. 18E, F). The dQ/dV analysis can provide more detailed insights into kinetics. As shown in FIG. 18G, the dQ/dV curves at C/20 of the three-layer cathode and the conventional cathode are very similar, with four pairs of peaks corresponding to the sequential intercalation reactions of NMC 811. However, for the reversed three-layer cathode, in addition to the shift of the peaks due to the larger overpotential, one pair of peaks at high voltage (around 3.6 V vs In—Li/Li⁺ or 4.2 V vs Li/Li⁺) is missing due to the sluggish kinetics. Specifically, the low SE content of the top layer creates significant resistance for the Li⁺ transfer into or out of the cathode, resulting in a rapid voltage rise to the cut-off voltage without the last phase transition (H2→H3) of NMC 811. When the rate increases to C/10 (FIG. 18H), the cell with the three-layer cathode still clearly shows the four pairs of peaks for the sequential intercalation reactions, indicating a homogeneity reaction throughout the cathode thickness. However, for the conventional and reversed cathodes, the four pairs of peaks become blurred, wider, or even disappear caused by reaction inhomogeneity in the electrode level during the charge and discharge process.³⁴ Overall, the three-layer cathode demonstrates better rate performance with more homogenous delithiation and lithiation reactions across the entire cathode. Although the three-layer cathode and reversed groups have the same tortuosity, they show dramatically different performances. We conducted simulations with the Newman p2D model to study the effect on the SOC uniformity of the three-layer design. In FIG. 21, the local SOC vs. position is shown for the NMC811 monolayer, three-layer, and reversed three-layer designs for a C/2 charge with 30 mg/cm² mass loading. The distribution of the SOC shows increased SOC near the separator for the three-layer design, and decreased SOC near the separator for the reversed three-layer design, compared to the monolayer. The result provides evidence that the appropriate allocation of SE content to match the Li⁺ flux over the whole thick cathode is an effective way to improve homogenous electrochemical reactions and the rate performance of the thick cathode.

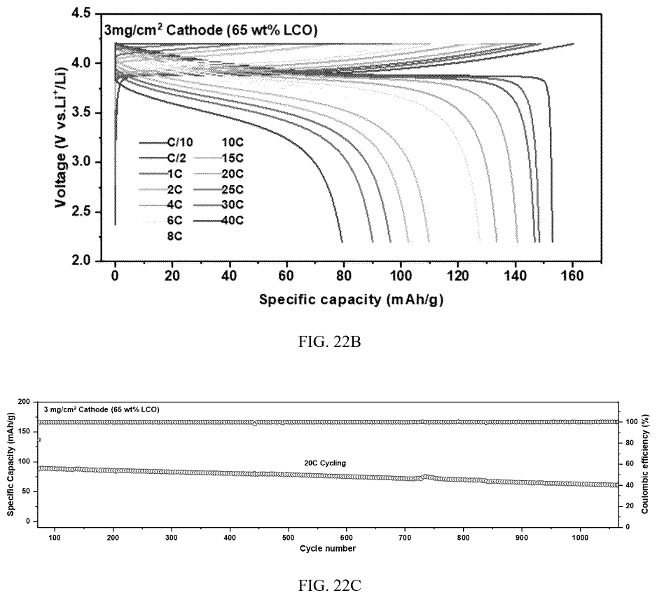

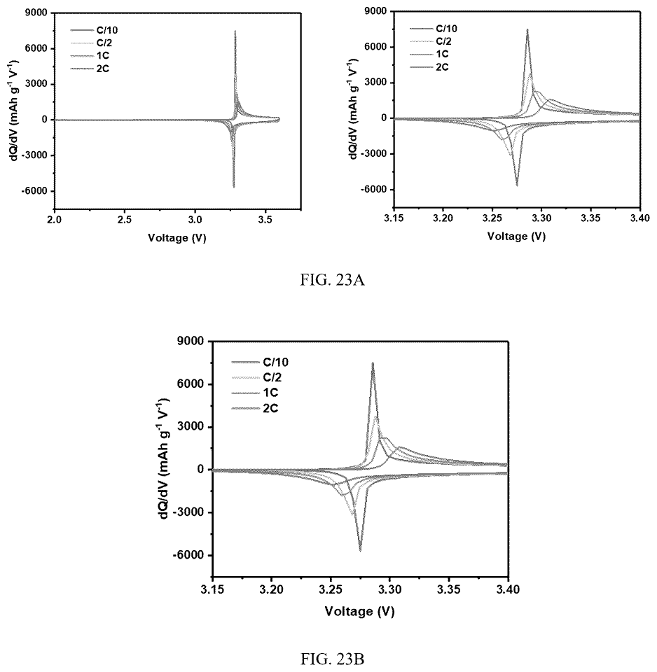

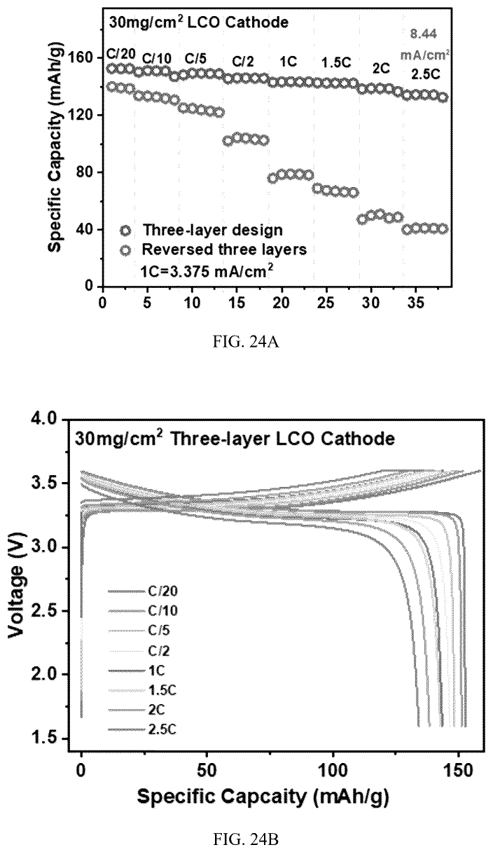

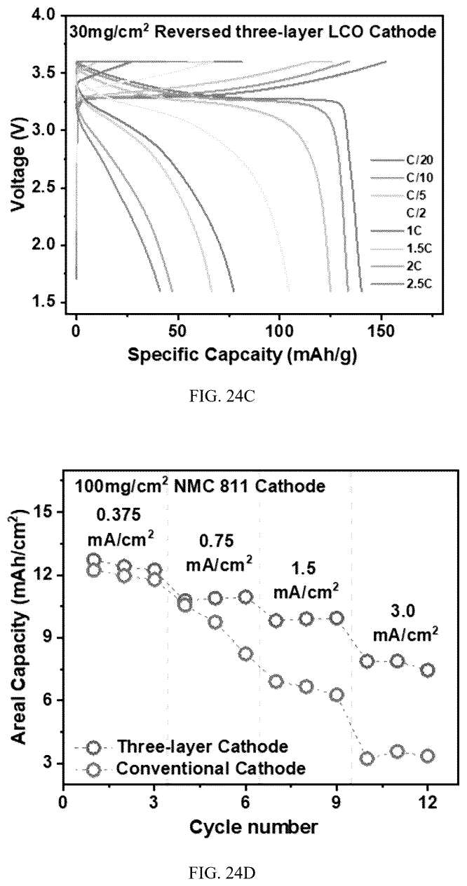

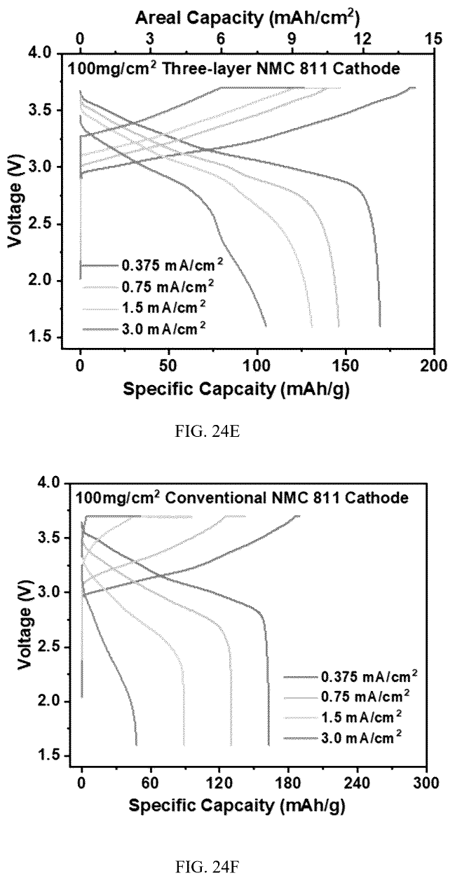

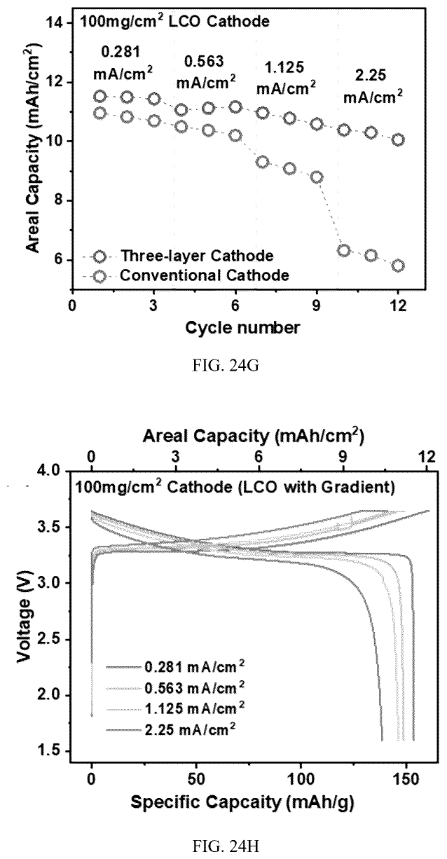

To further explore the performance of our three-layer design cathode, we introduced another CAM, LiCoO₂ (LCO). LCO shows much better C-rate performance on the material level (FIGS. 22A-C). In the dQ/dV curves for the low mass-loading (3 mg/cm²) LCO cell, there is almost no shift of the reaction peaks even increasing to 2C (FIGS. 23A-B). Therefore, LCO cathode can better exhibit the improvement of the ion transfer on the electrode level. The thick LCO cathode (30 mg/cm²) with the three-layer design shows almost no capacity decay even when increasing the rate to 2.5C (8.44 mA/cm²) with the areal capacity over 3.0 mAh/cm² (FIGS. 24A-B). In contrast, dramatic decay of the rate performance was observed for the ASSB with the reversed three-layer LCO cathode (FIG. 24C). Since there is no rate limitation from the material level, and the interface between SE and CAM is identical, the remarkable difference between two cells primarily relies on the different ion transport kinetics on the electrode level, which further highlights the significance of aligning the arrangement of the SE content with Li⁺ flux to the ion transport in the thick cathode.

The high mass-loading cathodes (100 mg/cm²) with the theoretical capacity of 15.0 and 11.25 mAh/cm² for NMC 811 and LCO as CAM were also studied (FIG. 24D-I). The high mass-loading NMC 811 cathode with the three-layer design exhibited around 189 and 170 mAh/g specific capacity for the first charge and discharge, equivalent to 14.25 and 12.75 mAh/cm² areal capacity under the current density of 0.38 mA/cm². Even under the current densities of 1.5 and 3.0 mA/cm², the cell can still obtain the capacities of 9.9 and 7.9 mAh/cm², which are 1.5 and 2.5 times better than the conventional cell, respectively. The high mass-loading LCO cathode with the three-layer design exhibited even better rate performance, achieving an areal capacity of 10.4 mAh/cm² at the current density of 2.25 mA/cm². All of them show obvious improvement rate performance compared with the traditional one-layer cathode further, proving the importance of aligning the SE arrangement with the Li⁺ flux on the thick electrode.

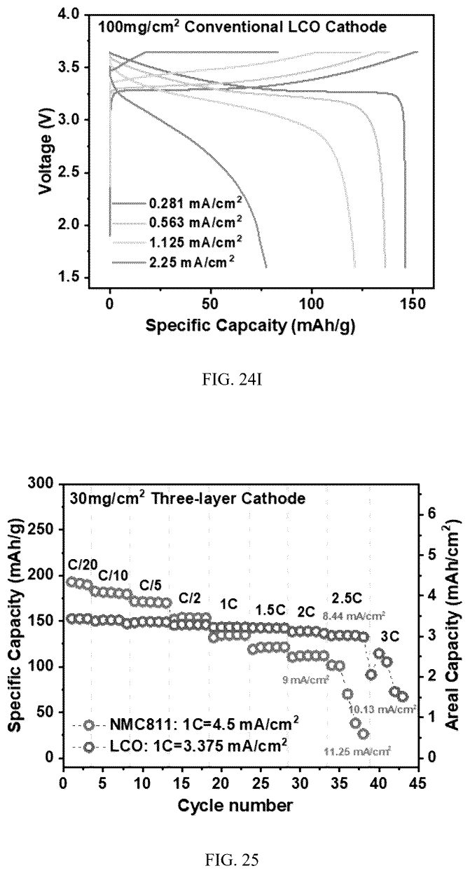

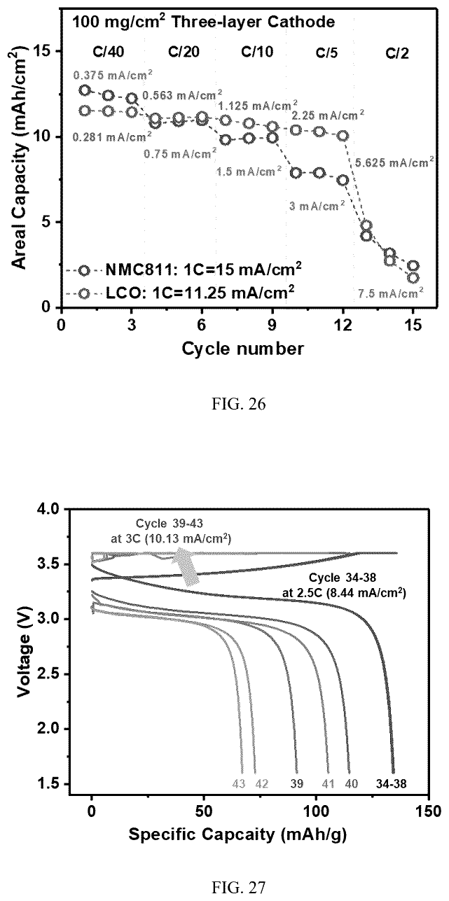

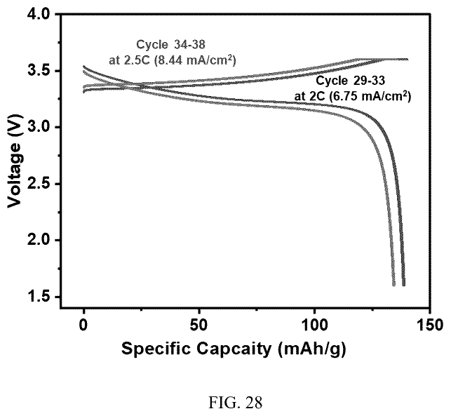

With the increase in current density over 10 mA/cm² for the 30 mg/cm² cathode or over 5 mA/cm² for the 100 mg/cm² cathode, all cells met an unnormal failure (FIGS. 25 and 26). The capacity suddenly decreases within a few cycles. For example, the cell with 30 mg/cm² LCO cathode cycled stably at 2.5 C with the current density of 8.44 mA/cm² (FIG. 27). However, when the current increased to 10.13 mA/cm², the overpotential suddenly increased even over the cutoff voltage. The constant current (CC) charge period disappeared, and the capacity was obtained by the constant voltage (CV) charge process. This phenomenon cannot be simply explained as the ohmic resistance because it is not linearly related to the current density if we compare it with the increase of the overpotential from 2C (6.75 mA/cm²) to 2.5C (8.44 mA/cm²) (FIG. 28). The unnormal fail is also not due to the rate performance of the CAM since both materials met the same issue under the similar current density. Therefore, the issue is still related to the ion transfer in the thick cathode, and there should be a critical current density for the thick cathode based on the SE content and distribution. Since the Li⁺ flux gradually increased with the thickness, but our cells only provide a three-level gradient, there are still mismatches of SE component and Li⁺ flux on the smaller scale. A smoother and more delicate arrangement of the SE will further increase the critical current density and benefit the rate performance of the thick cathode.

In summary, this work successfully visualized the lithium reaction gradients in an all-solid-state battery with a high mass-loading (33 mg/cm²) NMC811 cathode using operando neutron imaging. The results confirmed the inhomogeneous lithiation of CAM in the thick cathode, with a lithiation gradient from the solid electrolyte (SE) layer side to the current collector side. The electrochemical evaluations of the ASSBs with different cathode mass-loadings of 3, 10, and 30 mg/cm² further validated the inhomogeneous lithiation of CAM in the thick cathode, especially at high rates. Based on the study, ion transfer was identified as the key limitation causing kinetic issues in the thick cathode. We pioneered the concept of “Li⁺ flux” and its effect on ion transfer in the thick cathode of all-solid-state batteries. Due to the faradaic reaction of the cathode active materials, which consume or generate Li⁺ flux, the Li⁺ flux across the ion conductor (SE), catholyte, in the cathode accumulate in terms of the thickness of the cathode. The mismatch between the Li⁺ flux and ion transfer channel causes a huge obstacle for the Li⁺ transport in the thick cathode.

To address the ion transfer limitation arising from the significant variation in Li⁺ flux from the SE layer to the current collector side in the thick cathode, a tailored arrangement of the catholyte in the composite cathodes was designed and studied, resulting in significantly improved rate performances (171% of the capacity obtained in the conventional cathode at the current density of 9.0 mA/cm² for 30 mg/cm² NMC 811 cathode). The effectiveness of this gradient design was further demonstrated in high mass-loading cathodes (100 mg/cm²), which achieved areal capacities of 10.4 mAh/cm² at a current density of 2.25 mA/cm² with LCO cathode and 9.9 mAh/cm² at the current density of 1.50 mA/cm² for NMC cathode. We also observed a critical current density threshold in the thick electrodes, beyond which an abnormal capacity drop occurs attributed to the mismatch between the catholyte and Li⁺ flux at smaller length scales. This work highlights the importance of understanding and optimizing ion transport in high mass-loading cathodes for the development of high-performance all-solid-state batteries. The insights gained from operando neutron imaging and the demonstrated effectiveness of the gradient design provide valuable inspiration for future advancements in high mass-loading all-solid-state battery fast charge technology.

### Methods

Materials preparation: Solid electrolyte, Li_{5.4}PS_{4.4}Cl_{1.6}, was prepared by high-energy ball milling with an annealing process.⁴¹ Li₂S (Sigma-Aldrich, 99.98%), P₂S₅(Sigma-Aldrich, 99%), and LiCl (Sigma-Aldrich, 99%) were stoichiometrically mixed through a ball milling for 10 h at 500 rpm. After that, the mixture was annealed at 510° C. for 2 h. The cathode active materials (CAMs), Single-crystal NMC 811 (Nanoramic Inc., USA) and Lithium cobalt oxide (Sigma-Aldrich, 99.8%), were coated with Li₂SiOₓ through a wet chemical method to stabilize their interface between the SE.⁴² Graphitized carbon nanofibers (US Research Nanomaterials Inc., 99.9%) were used as the electronic conductive additive. The composite cathodes with different weight percentages (65%, 75%, and 85%) of CAMs were prepared by mixing Li₂SiOₓ coated CAMs, SE, and carbon additive. The composite cathodes with different weight percentages (65%, 75%, and 85%) of CAMs were prepared by mixing Li₂SiOₓ-coated CAMs, SE, and carbon additive (65%, 33%, 2% for 65% CAM cathode; 75%, 23.5%, 1.5% for 75% CAM cathode; 85%, 14%, 1% for 85% CAM cathode) by hand milling gently for 30 mins.

Operando Neutron imaging: The operando neutron imaging was taken on the Multimodal Advanced Radiography Station (MARS), HFIR beamline CG-1D, at Oak Ridge National Laboratory. The detector-to-pinhole distance was 6.59 m. The pinhole diameter was 11 mm. The cells used for operando neutron imaging were assembled in the argon-filled glovebox. 15 mg of SE were prepressed by 50 MPa within the quartz tube with a diameter of 4 mm. Then, the cathode powder was cast onto one side of the SE pallet with a pressure of 300 MPa. One piece of In (15 mg, Sigma, 99.99%) and one piece of ⁶Li metal (0.2 mg, Cambridge Isotope Laboratories, Inc., 95%) were sequentially attached to the other side of the SE pallet. An aluminum pillar and a stainless steel pillar were used as the current collector for the cathode side and anode side respectively. A stacking pressure of 50 MPa was applied to the cell by an aluminum framework. All gaps on the cell were further sealed by sealing grease and hot melt glue. The battery was operated by the VMP3 potentiostat (BioLogic) with in-situ electrochemical impedance spectroscopy (EIS) measurement with an AC amplitude of 10 mV from 7 MHz to 10 mHz. 10 points were collected per charge/discharge. Before the EIS test, the cell was rested to reach a quasi-stationary potential with a dV/dT<1 mV/min. The open-circuit voltage (OCV) drift correction function was applied during the EIS measurement. For the operando neutron imaging collecting, the cell was placed in front of a scientific Complementary Metal-Oxide-Semiconductor (sCMOS) camera system (Zyla5.5, Andor Technology plc. Belfast, UL) with a 20 μm thick Gd202S: Tb scintillator screen. The exposure time for each image was 5 minutes under the neutron beam with a wavelength range from 0.8 to 6 Å and a peak flux of 2.2×10⁶ n cm⁻² s⁻¹ at 2.6 Å. The pixel size of the operando neutron image is 7.5 μm*7.5 μm. Open beam and dark field images were collected before and after the operando neutron imaging test. The ambient temperature was around 20° C. The neutron imaging Jupyter Notebook developed by ORNL and Fiji-image software were used for the data processing of the operando neutron images.

All-solid-state Batteries Assembling and Electrochemical tests: The ASSBs were assembled by the cold pressing method in the argon-filled glovebox. 100 mg/cm² of SE was first pre-pressed into the homemade PEEK cell with a diameter of ½ inch (12.7 mm) under 50 MPa. Different amounts of cathode materials were further cast on one side of the SE pellet. For the multi-layer cathode, the cathode materials were cast layer by layer with a pre-press pressure of 10 MPa. The cathode and SE were further densified under the pressure of 300 MPa by two steel pillars. One piece of In foil and Li foil were sequentially attached to the other side of the SE pellet. An aluminum foil and a copper foil were used as the current collectors for the cathode and anode separately. A stacking pressure of 50 MPa was applied to the cell by a stainless-steel framework during cycling. For the battery test at 60° C., all batteries were placed in the gravity convection oven (Fisher scientific) and cycled by a battery cycler system (LAND Electronic Co., Ltd), with a cut of voltage of 1.6 to 3.7 V for NMC cathode and 1.6 to 3.6 V for LCO cathode. For the CC-CV charge process, the cut-off conditions were set with the current reaching 1/10 of the current under the CC process or the time reaching the maximum time under the specific rate (such as 1 hour for 1C). All groups were tested at least twice.

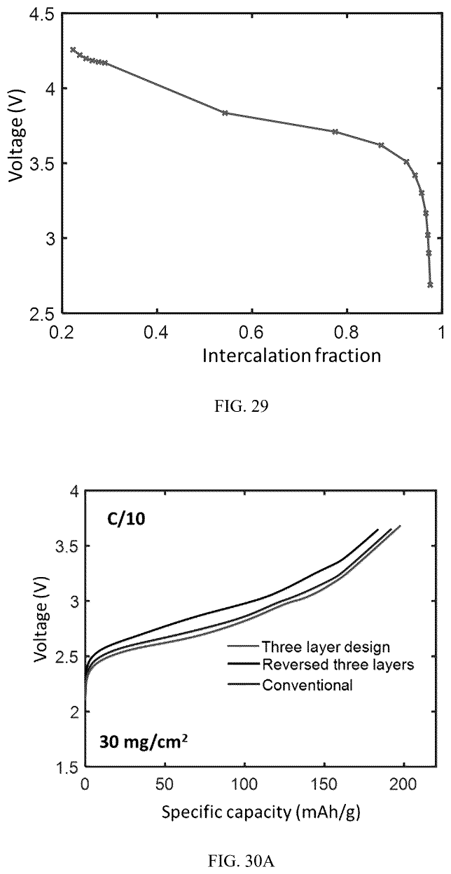

Theoretical Modeling: Simulations of the NMC811 cathode were conducted using the Newman P2D model implanted in COMSOL Multiphysics. A summary of the parameters used for this study are given in Table 2 and FIG. 29, and the governing equations have been described in previous work⁴¹. The electrolyte fractions were determined from the mass loading of the sample and measured thickness of the electrodes, and a significant porosity in the samples was determined (25%). Several model parameters were chosen empirically to match trends in experimental data, notably the ionic conductivity in the electrolyte phase and the tortuosity of each layer in the three-layer electrode designs. The ionic conductivity in the catholyte was assumed to be 0.1 S/m, which is less than that of experimental measurements of the solid electrolyte. This assumption justified in that the solid electrolyte structure is altered during the processing of the catholyte. The tortuosity τ² values were arupproximated by a Bruggebman type correlation for different electrolyte fractions (ϵₑ) in the layered structures:

$${τ}^{2} = {ϵ}_{e}^{- 2.8} ;$$

this is similar to that from Stavola et. al.²¹ (which reported a Bruggeman correlation of

$${τ}^{2} = {ϵ}_{e}^{- 2.7} ) .$$

This correlation was used to calculate tortuosity for the low-electrolyte fraction layer C (ϵₑ=0.26, τ²=42), and “normal”-electrolyte fraction layer B (ϵₑ=0.35, τ²=19). However, the “high” electrolyte faction layer A with this correlation (ϵₑ=0.44, τ²=10) did not produce a substantial change in predicted capacity expected for the three-layer electrode model, as compared to experiments; to account for this, it was assumed that the tortuosity was lower, with a value of τ²=5; this may account for different local structure of the electrolyte at higher electrolyte fractions, deviating from the low electrolyte fraction values.

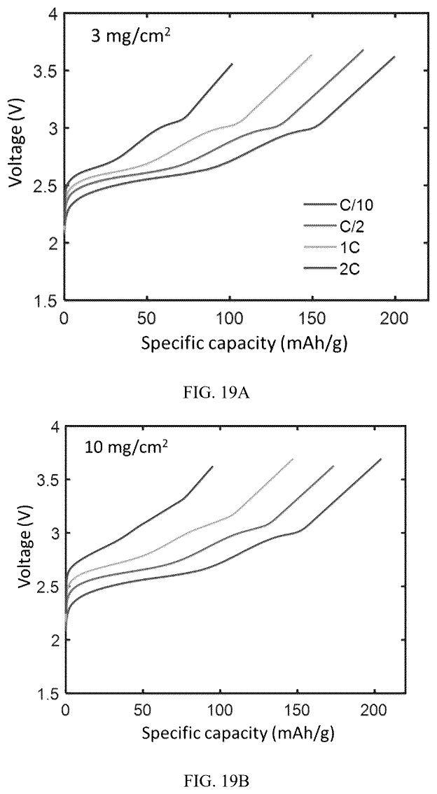

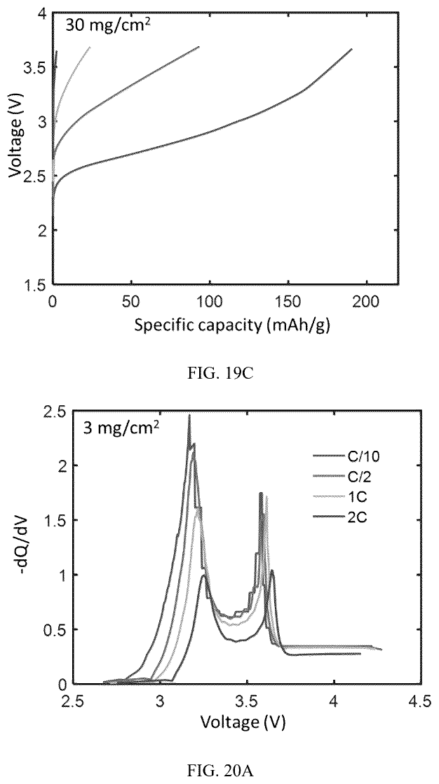

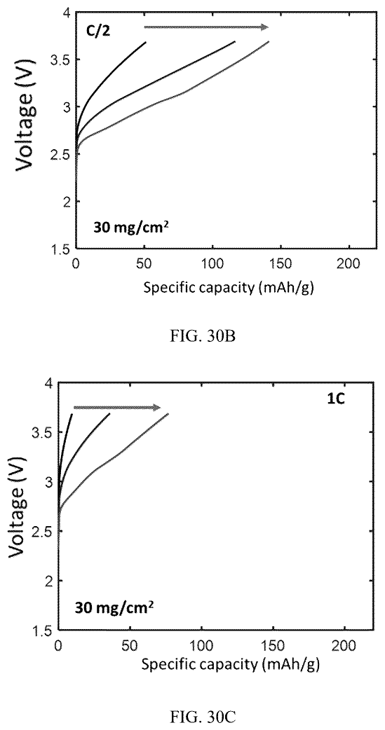

Simulations were conducted to evaluate the predicted voltage response and capacity, local average intercalation fraction, and particle surface intercalation fraction for different electrode designs (conventional, three-layer or reversed three-layer), various charge rates, and mass loadings. Simulated voltage profiles for varying mass loading and varying layer design are shown in FIGS. 19 and 30, respectively, and can be compared to FIGS. 15A-C and 18D-F, respectively. It is emphasized that these models are used to elucidate trends in the experimental data rather than building detailed predictive models.

### REFERENCES

1 Randau, S. et al. Benchmarking the performance of all-solid-state lithium batteries. Nature Energy 5, 259-270 (2020).
2 Heubner, C. et al. From lithium-metal toward anode-free solid-state batteries: current developments, issues, and challenges. Advanced Functional Materials 31, 2106608 (2021).
3 Bielefeld, A., Weber, D. A. & Janek, J. r. Microstructural modeling of composite cathodes for all-solid-state batteries. The journal of physical chemistry C 123, 1626-1634 (2018).
4 Wang, J. et al. High-areal-capacity thick cathode with vertically-aligned micro-channels for advanced lithium ion batteries. Energy Storage Materials 39, 287-293 (2021).
5 Yang, X., Doyle-Davis, K., Gao, X. & Sun, X. Recent progress and perspectives on designing high-performance thick electrodes for all-solid-state lithium batteries. ETransportation 11, 100152 (2022).
6 Vargas-Barbosa, N. M. & Roling, B. Dynamic ion correlations in solid and liquid electrolytes: how do they affect charge and mass transport? ChemElectroChem 7, 367-385 (2020).
7 Shkrob, I. A., Okasinski, J. S., Rodrigues, M.-T. F. & Abraham, D. P. Electrochemical Modeling and Experimental Verification of Lithiation Gradients in Oxide Cathodes of Lithium-Ion Cells. Journal of the Electrochemical Society 169, 040503 (2022).
8 Singh, M., Kaiser, J. & Hahn, H. Thick electrodes for high energy lithium ion batteries. Journal of The Electrochemical Society 162, A1196 (2015).
9 Li, Y et al. A lithium superionic conductor for millimeter-thick battery electrode. Science 381, 50-53, doi:doi:10.1126/science.add7138 (2023).
10 Adeli, P. et al. Boosting solid-state diffusivity and conductivity in lithium superionic argyrodites by halide substitution. Angewandte Chemie International Edition 58, 8681-8686 (2019).
11 Zhou, L., Assoud, A., Zhang, Q., Wu, X. & Nazar, L. F. New family of argyrodite thioantimonate lithium superionic conductors. Journal of the American Chemical Society 141, 19002-19013 (2019).
12 Wu, D., Chen, L., Li, H. & Wu, F. Solid-state lithium batteries—from fundamental research to industrial progress. Progress in Materials Science, 101182 (2023).
13 Janek, J. & Zeier, W. G. Challenges in speeding up solid-state battery development. Nature Energy 8, 230-240 (2023).
14 Ye, L. & Li, X. A dynamic stability design strategy for lithium metal solid state batteries. Nature 593, 218-222, doi:10.1038/s41586-021-03486-3 (2021).
15 Yan, W. et al. Hard-carbon-stabilized Li—Si anodes for high-performance all-solid-state Li-ion batteries. Nature Energy 8, 800-813, doi:10.1038/s41560-023-01279-8 (2023).
16 Ohno, S., Rosenbach, C., Dewald, G. F., Janek, J. & Zeier, W. G. Linking solid electrolyte degradation to charge carrier transport in the thiophosphate-based composite cathode toward solid-state lithium-sulfur batteries. Advanced Functional Materials 31, 2010620 (2021).
17 Bielefeld, A., Weber, D. A., Rueß, R., Glavas, V. & Janek, J. Influence of lithium ion kinetics, particle morphology and voids on the electrochemical performance of composite cathodes for all-solid-state batteries. Journal of The Electrochemical Society 169, 020539 (2022).
18 Minnmann, P., Quillman, L., Burkhardt, S., Richter, F. H. & Janek, J. Editors' choice—quantifying the impact of charge transport bottlenecks in composite cathodes of all-solid-state batteries. Journal of The Electrochemical Society 168, 040537 (2021).
19 Wang, Y & Li, X. Fast Kinetics Design for Solid-State Battery Device. Advanced Materials, 2309306 (2024).
20 Davis, A. L. et al. Rate limitations in composite solid-state battery electrodes: revealing heterogeneity with operando microscopy. ACS Energy Letters 6, 2993-3003 (2021).
21 Stavola, A. M. et al. Lithiation Gradients and Tortuosity Factors in Thick NMC111-Argyrodite Solid-State Cathodes. ACS Energy Letters 8, 1273-1280 (2023).
22 Cao, D., Zhang, Y, Ji, T. & Zhu, H. In operando neutron imaging characterizations of all-solid-state batteries. MRS Bulletin 48, 1257-1268, doi:10.1557/s43577-023-00611-7 (2023).
23 Ziesche, R. F., Kardjilov, N., Kockelmann, W., Brett, D. J. & Shearing, P. R. Neutron imaging of lithium batteries. Joule 6, 35-52 (2022).
24 Wei, X., Wang, X., An, Q., Han, C. & Mai, L. Operando X-ray Diffraction Characterization for Understanding the Intrinsic Electrochemical Mechanism in Rechargeable Battery Materials. Small Methods 1, 1700083, doi:10.1002/smtd.201700083 (2017).
25 Ghigna, P. & Quartarone, E. Operando x-ray absorption spectroscopy on battery materials: a review of recent developments. Journal of Physics: Energy 3, 032006 (2021).
26 Cao, D. et al. Li Dynamics in Mixed Ionic-Electronic Conducting Interlayer of All-Solid-State Li-metal Batteries. Nano Letters (2024).
27 Cao, D. et al. Nondestructively Visualizing and Understanding the Mechano-Electro-chemical Origins of “Soft Short” and “Creeping” in All-Solid-State Batteries. Advanced Functional Materials 33, 2307998 (2023).
28 Bradbury, R. et al. Visualizing Reaction Fronts and Transport Limitations in Solid-State Li—S Batteries via Operando Neutron Imaging. Advanced Energy Materials 13, 2203426 (2023).
29 Bradbury, R. et al. Visualizing Lithium Ion Transport in Solid-State Li—S Batteries Using 6Li Contrast Enhanced Neutron Imaging. Advanced Functional Materials 33, 2302619 (2023).
30 Lodding, A., Mundy, J. & Ott, A. Isotope inter-diffusion and self-diffusion in solid lithium metal. physica status solidi 38, 559-569 (1970).
31 Xiao, Y et al. Understanding interface stability in solid-state batteries. Nature Reviews Materials 5, 105-126, doi:10.1038/s41578-019-0157-5 (2020).
32 Banerjee, A., Wang, X., Fang, C., Wu, E. A. & Meng, Y S. Interfaces and interphases in all-solid-state batteries with inorganic solid electrolytes. Chemical reviews 120, 6878-6933 (2020).
33 Tan, D. H. S. et al. Elucidating Reversible Electrochemical Redox of Li6PS5Cl Solid Electrolyte. ACS Energy Letters 4, 2418-2427, doi:10.1021/acsenergylett.9b01693 (2019).
34 Kim, J. et al. Electrochemical profiling method for diagnosis of inhomogeneous reactions in lithium-ion batteries. Cell Reports Physical Science 4 (2023).
35 Noh, H.-J., Youn, S., Yoon, C. S. & Sun, Y.-K. Comparison of the structural and electrochemical properties of layered Li [NixCoyMnz]O2 (x=1/3, 0.5, 0.6, 0.7, 0.8 and 0.85) cathode material for lithium-ion batteries. Journal of power sources 233, 121-130 (2013).
36 Chen, H. et al. Tortuosity effects in lithium-metal host anodes. Joule 4, 938-952 (2020).
37 Song, K., Zhang, C., Hu, N., Wu, X. & Zhang, L. High performance thick cathodes enabled by gradient porosity. Electrochimica Acta 377, 138105, doi:10.1016/j.electacta.2021.138105 (2021).
38 Chouchane, M., Yao, W., Cronk, A., Zhang, M. & Meng, Y S. Improved Rate Capability for Dry Thick Electrodes through Finite Elements Method and Machine Learning Coupling. ACS Energy Letters 9, 1480-1486, doi:10.1021/acsenergylett.4c00203 (2024).
39 Shodiev, A. et al. Deconvoluting the benefits of porosity distribution in layered electrodes on the electrochemical performance of Li-ion batteries. Energy Storage Materials 47, 462-471, doi:10.1016/j.ensm.2022.01.058 (2022).
40 Mijailovic, A. S. et al. Analytical and Numerical Analysis of Lithium Plating Onset in Single and Bilayer Graphite Electrodes during Fast Charging. Journal of The Electrochemical Society 169, 060529, doi:10.1149/1945-7111/ac73bb (2022).
41 Cao, D. et al. Enhancing Lithium Stripping Efficiency in Anode-Free Solid-State Batteries through Self-Regulated Internal Pressure. Nano Letters 23, 9392-9398 (2023).
42 Cao, D. et al. Unveiling the mechanical and electrochemical evolution of nanosilicon composite anodes in sulfide-based all-solid-state batteries. Advanced Energy Materials 13, 2203969 (2023).

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. An electrode, comprising a first layer, a second layer, and a third layer, wherein:
each of the first layer, the second layer, and the third layer comprises electrode-active material, solid electrolyte, and a carbon material;
the first layer is coupled to the second layer;
the second layer is coupled to the third layer;
amount of the solid electrolyte in the first layer is greater than amount of the solid electrolyte in the second layer, and the amount of the solid electrolyte in the second layer is greater than amount of the solid electrolyte in the third layer; and
the electrode has an electrode-active material loading of at least about 1 mg/cm².

2. The electrode of claim 1, wherein: the amount of the solid electrolyte in the first layer is from about 30 wt. % to about 35 wt. %; the amount of the solid electrolyte in the second layer is from about 20 wt. % to about 25 wt. %; and the amount of the solid electrolyte in the third layer is from about 10 wt. % to about 15 wt. %.

3. The electrode of claim 1, wherein the electrode-active material comprises lithium, nickel, manganese, cobalt, or a combination thereof.

4. The electrode of claim 1, wherein the electrode-active material is LiCoO₂ or LiNi_{0.8}Mn_{0.1}Co_{0.1}O₂.

5. The electrode of claim 1, wherein the solid electrolyte comprises lithium and sulfur.

6. The electrode of claim 1, wherein the solid electrolyte is Li_{5.4}PS_{4.4}Cl_{1.6}.

7. The electrode of claim 1, wherein the carbon material comprises carbon nanofibers.

8. The electrode of claim 1, wherein the electrode-active material loading is at least about 20 mg/cm².

9. The electrode of claim 1, wherein the electrode has a thickness of at least about 100 μm.

10. A method of forming an electrode comprising a first layer, a second layer, and a third layer, the method comprising:
applying a first mixture comprising electrode-active material, solid electrolyte, and a carbon material onto a substrate to form the first layer;
applying a second mixture comprising the electrode-active material, the solid electrolyte, and the carbon material onto the first layer to form the second layer; and
applying a third mixture comprising the electrode-active material, the solid electrolyte, and the carbon material onto the second layer to form the third layer, thereby forming the electrode, wherein:
each of the first layer, the second layer, and the third layer comprises the electrode-active material, the solid electrolyte, and the carbon material;
the first layer is coupled to the second layer;
the second layer is coupled to the third layer;
amount of the solid electrolyte in the first layer is greater than amount of the solid electrolyte in the second layer, and the amount of the solid electrolyte in the second layer is greater than amount of the solid electrolyte in the third layer; and
the electrode has an electrode-active material loading of at least about 1 mg/cm².

11. The method of claim 10, wherein the substrate comprises the solid electrolyte.

12. The method of claim 10, wherein: applying the first mixture comprises depositing the first mixture onto the substrate and pressing the deposited first mixture at about 10 MPa; applying the second mixture comprises depositing the second mixture onto the first layer and pressing the deposited second mixture at about 10 MPa; and applying the third mixture comprises depositing the third mixture onto the second layer and pressing the deposited third mixture at about 10 MPa.

13. The method of claim 10, further comprising applying a pressure to the electrode.

14. The method of claim 13, wherein a pressure of about 300 MPa is applied.

15. The method of claim 13, wherein the pressure is applied using two steel pillars.

16. The method of claim 10, wherein: the amount of the solid electrolyte in the first mixture is from about 30 wt. % to about 35 wt. %; the amount of the solid electrolyte in the second mixture is from about 20 wt. % to about 25 wt. %; and the amount of the solid electrolyte in the third mixture is from about 10 wt. % to about 15 wt. %.

17. The method of claim 10, wherein the electrode-active material comprises lithium, nickel, manganese, cobalt, or a combination thereof.

18. The method of claim 10, wherein the solid electrolyte comprises lithium and sulfur.

19. The method of claim 10, wherein the carbon material comprises carbon nanofibers.

20. A battery comprising: a solid electrolyte; and the electrode of claim 1.
